(19) United States
(12) Patent Application Publication
(10) Pub. No.: US 2005/0181226 A1
(43) Pub. Date: Aug. 18, 2005

(54) Method and apparatus for selectively changing thin film composition during electroless deposition in a single chamber

(75) Inventors: Timothy W. Weidman, Sunnyvale, CA (US); Ian Pancham, San Francisco, CA (US); Dmitry Lubomirsky, Cupertino, CA (US); Arulkumar Shanmugasundram, Sunnyvale, CA (US); Yosef Shacham-Diamand, Ithaca, NY (US); Farhad Moghadam, Los Gatos, CA (US)

Correspondence Address: MOSER, PATTERSON & SHERIDAN, LLP;APPLIED MATERIALS, INC., 3040 POST OAK BOULEVARD, SUITE 1500, HOUSTON, TX, 77056, US

(73) Assignee: Applied Materials, Inc.

(21) Appl. No.: 11/040,962

(22) Filed: Jan. 22, 2005

Related U.S. Application Data
(60) Provisional application No. 60/539,543, filed on Jan. 26, 2004.

(51) Int. Cl. B05C 3/00; B05D 1/18

(52) U.S. Cl. 428/544; 427/437; 118/400

(57) ABSTRACT

A method and apparatus for electrolessly depositing a multilayer film using a fluid processing solution(s) that can clean and then electrolessly deposit a metal films having discrete or varying composition onto a conductive surface using a single processing cell. The process advantageously includes in-situ cleaning step in order to minimize the formation of oxides on the conductive surfaces, by minimizing or preventing the exposure of the conductive surfaces to oxygen (e.g., air) between the cleaning step and an electroless deposition process step(s). In one aspect, the chemical components used in the fluid processing solution(s) are selected so that the interaction of various chemical components will not drastically change the desirable properties of each of the interacting fluids, generate particles in the fluid lines or on the surface of the substrate, and/or generate a significant amount of heat which can damage the hardware or significantly change the electroless process results. In another aspect, no rinsing steps are required between the various deposition steps used to form the various layers, since the processing fluids are selected so that they are compatible with each other. In another aspect, throughout the process the conductive surfaces are continually in contact with various chemical components that will inhibit oxidation of the conductive surfaces and/or reduce the oxidized metal surfaces. In one aspect, a multilayer structure can formed on the surface of the conductive surface using the continuous electroless deposition process where the first layer of the multilayer structure has at least two of the following elements cobalt (Co), tungsten (W), phosphorus (P) or boron (B); and a second layer contains at least two of the following elements cobalt (Co), boron (B) or phosphorus (P). Formation of a multilayer structure on the conductive surface may have advantage since each deposited layer can have differing properties which when placed together will form a layer that has improved properties over a single deposited layer.

### CROSS-REFERENCE TO RELATED APPLICATIONS

This application claims benefit of provisional U.S. patent application Ser. No. 60/539,543, filed Jan. 26, 2004, entitled “Method and Apparatus For Selectively Changing Thin Film Composition During Electroless Deposition In A Single Chamber,” [Attorney Docket No. 8926L] and is herein incorporated by reference.

### BACKGROUND OF THE INVENTION

1. Field of the Invention

Embodiments of the present invention generally relate to a method and apparatus for electrolessly depositing a thin film layer on a substrate.

2. Description of the Related Art

Recent improvements in circuitry of ultra-large scale integration (ULSI) on substrates indicate that future generations of integrated circuit (IC) semiconductor devices will require smaller multi-level metallization. The multilevel interconnects that lie at the heart of this technology require planarization of interconnects formed in high aspect ratio features, including contacts, vias, lines and other features. Reliable formation of these interconnects is very important to the success of ULSI and to the continued effort to increase circuit density by decreasing the dimensions of semiconductor features and decreasing the widths of interconnects (e.g., lines) to 0.13 μm and less. Currently, copper and its alloys have become the metals of choice for sub-micron interconnect technology because copper (Cu) has a lower resistivity than aluminum (Al) (i.e., 1.67 μΩ-cm for Cu as compared to 3.1 μΩ-cm for Al), a higher current carrying capacity, and significantly higher electromigration resistance.

However, despite the positive attributes of Cu, Cu interconnects are susceptible to copper diffusion, electromigration related failures, and oxidation related failures. Typically, a liner barrier layer is used to encapsulate the sides and bottom of the Cu interconnect to prevent diffusion of Cu to the adjacent dielectric layers. The oxidation and electromigration related failures of Cu interconnects can be significantly reduced by depositing a thin metal capping layer of, for example, cobalt tungsten phosphorus (CoWP), cobalt tin phosphorus (CoSnP), and cobalt tungsten phosphorus boron (CoWPB), onto the surface of the Cu interconnect formed after a chemical mechanical planarization (CMP) process has been performed. In addition, to increase adhesion and selectivity of the deposited capping layer over the Cu interconnect, an activation layer such as palladium (Pd) or platinum (Pt) may be deposited on the surface of the Cu interconnection prior to depositing the capping layer.

Copper oxide formation can increase the electrical resistance of a formed Cu interconnect and thus reduce the reliability of the overall circuit. Oxidation of the Cu interconnect is particularly challenging due to the numerous instances of exposure to oxygen (e.g., air) during processing, as well as sources of oxygen contained within the IC. device itself (low k dielectrics and air-gap technology). Prior to depositing the capping layer over the surface of the Cu interconnect, the surface of the Cu interconnect is typically cleaned with a cleaning solution to remove contaminants and oxides in one chamber and then the substrate is subsequently transferred to another chamber to deposit a capping layer over the pre-cleaned Cu interconnect. During the process of transferring the substrate, the pre-cleaned Cu interconnect is particularly susceptible to oxidation from any available source of oxygen (e.g., atmosphere).

After depositing a capping layer, high processing temperatures reaching 400 ° C. to 450° C. for periods of about 8 hours during back-end-of-the-line (BEOL) layer processing and chip packaging lead to oxidation of Co alloys of the thin capping layers. In particular, oxidation is particularly detrimental in thinner capping layers having thicknesses of less than about 150 Å, for example, a 70 Å layer of COWP or COWPB.

Therefore, there is a need for a method and apparatus which combines pre-cleaning and electroless plating in a single chamber without intermediate exposure of the substrate to air, and furthermore there is a need for a method and apparatus to provide the flexibility to change the electroless bath composition to change the deposited film composition to achieve different application dependent film properties, such as, oxidation resistance or to achieve a stack of thin films such as in a MRAM application.

### SUMMARY OF THE INVENTION

The present invention generally provides a method of forming two or more metal layers on an exposed conductive surface on a substrate using a continuous electroless deposition process comprising: forming a first electroless deposited layer using a first processing solution that contains a concentration of a first chemical component that will remove or reduce metal oxides formed on a conductive surface on a substrate and forming a second electroless deposited layer on the first electrolessly deposited layer using a second processing solution that contains a concentration of the first chemical component, wherein the first component contained in the first processing solution and the second processing solution is in continuous contact with the conductive surface once the process of forming the first electroless deposited layer has begun until the process of forming the second electroless deposited layer has finished.

The present invention generally provides a continuous electroless deposition process for fabricating a multilayered film on a conductive surface on a substrate, comprising the following steps: electrolessly depositing a first layer on a conductive surface on a substrate by completing at least one of the following steps: delivering a first processing solution to the surface of the substrate, wherein the first processing solution comprises a first metal solution and a first buffered reducing agent solution, and delivering a second processing solution to the surface of the substrate, wherein the second processing solution comprises a second metal solution, a buffered cleaning solution and a second buffered reducing agent solution, and electrolessly depositing a second layer on the first layer by completing at least one of the following steps: delivering a third processing solution to the surface of the substrate, wherein the third processing solution comprises a third metal solution and a third buffered reducing agent solution, and delivering a fourth processing solution to the surface of the substrate, wherein the fourth processing solution comprises a fourth metal solution, a buffered cleaning solution and a fourth buffered reducing agent solution.

The present invention generally provides a continuous electroless deposition process for fabricating a multilayered film on a conductive surface on a substrate, comprising the sequential steps of: flowing a first solution containing a buffered cleaning solution over a conductive surface on a substrate, electrolessly depositing a first layer having a first composition on the conductive surface by: adding a flow of a first metal solution to the flow of the first solution and adding a flow of a first buffered reducing agent solution to flow of the first solution and electrolessly depositing a second layer having a second composition on the conductive surface by: adding a flow of a second metal solution to the flow of the first solution, and adding a flow of a second buffered reducing agent solution to flow of the first solution.

The present invention generally provides a continuous electroless deposition process for fabricating a multilayered film on a conductive surface on a substrate, comprising the sequential steps of: flowing a first combined flow including a buffered cleaning solution over the conductive surface, adding a metal solution to the flowing buffered cleaning solution, adding a buffered reducing agent solution to the flowing buffered cleaning solution to form a first electroless plating solution and electrolessly depositing a first layer having a first composition on the conductive surface, and recirculating the buffered cleaning solution, the metal solution and the buffered reducing agent solution to autocatalytically deposit a second layer over the first layer.

The present invention generally provides an apparatus for forming a multilayered film on a conductive surface of a substrate comprising: a substrate support mounted in an electroless plating cell having a substrate receiving surface, a fluid delivery line that is in communication with a substrate positioned on the substrate receiving surface, a first fluid metering device that is in communication with a first fluid source and the fluid delivery line, a second fluid metering device that is in communication with a second fluid source and the fluid delivery line, and a controller adapted to control the concentration and flow rate of a fluid contained in the fluid delivery line by controlling the flow delivered by the first and second fluid metering devices.

The present invention generally provides a multilayer structure formed on the surface of a copper interconnect comprising: a first layer that contains at least two of the following elements cobalt (Co), tungsten (W), phosphorus (P) or boron (B), and a second layer that contains at least two of the following elements cobalt (Co), boron (B) or phosphorus (P).

The present invention generally provides a continuous electroless deposition process for fabricating a multilayered film on a conductive surface on a substrate, comprising the sequential steps of: flowing a preclean solution containing an acid over a conductive surface on a substrate retained in a first processing chamber, transfer the substrate from a first processing chamber to a second processing chamber, electrolessly depositing a first layer having a first composition on the conductive surface by delivering a first electroless plating solution that contains at least a first metal solution and a first buffered reducing agent solution to the conductive surface, electrolessly depositing a second layer having a second composition on the conductive surface by delivering a second electroless plating solution that contains at least a second metal solution and a second buffered reducing agent solution to the conductive surface, wherein the composition of the first layer and the second layer are different.

The present invention generally provides a method of forming two or more metal layers on an exposed conductive surface on a substrate using a continuous electroless deposition process comprising: characterizing the density and/or surface area of the conductive surfaces found on a surface of a substrate, adjusting the metal ion concentration in a first electroless processing solution based on the characterized conductive surface data, forming an first layer on the conductive surfaces on the substrate using the first electroless processing solution, forming a second electroless processing solution that contains a stabilizer, and forming a second layer on the first layer using the second electroless processing solution.

The present invention generally provides a continuous electroless deposition process for fabricating a multilayered film on a conductive surface on a substrate, comprising the sequential steps of: flowing a first solution containing a buffered cleaning solution over a conductive surface on a substrate, flowing the second solution containing a buffered cleaning solution, a first metal solution, and a first buffered reducing agent solution over a conductive surface on a substrate, halting the flow of the second solution after a puddle of the second solution is formed over the conductive surfaces on the substrate, pausing for a first user defined time, flowing the third solution containing a buffered cleaning solution, a second metal solution, and a second buffered reducing agent solution over a conductive surface on a substrate, and halting the flow of the third solution after a puddle of the third solution is formed over the conductive surfaces on the substrate.

The present invention generally provides a method of forming two or more metal layers on an exposed conductive surface on a substrate using a continuous electroless deposition process comprising: cleaning a surface of a substrate using a buffered cleaning solution, forming a first electroless deposited layer comprising elements selected from the group of cobalt, molybdenum, tungsten, boron and phosphorus, and forming a first electroless deposited layer consisting essentially of cobalt and phosphorus or cobalt and boron.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A, 1B and 1C schematically depict cross-sectional views for forming a capping layer, according to an embodiment of the invention;

FIGS. 2A, 2B, 2C and 2D schematically depict cross-sectional views for forming a capping layer, according to another embodiment of the invention;

FIG. 3 is a flow chart of steps for forming a thin metal layer over a conductive surface 6A, in accordance with various embodiments of the invention;

FIG. 4 depicts a perspective and partial sectional view of an exemplary electroless fluid system and electroless plating cell with head assembly for forming a thin metal film, in accordance with various embodiments of the invention;

FIG. 5 schematically depicts a partial cross-sectional view of an exemplary face up type electroless fluid processing cell, in accordance with an embodiment of the invention; and

FIG. 6 schematically depicts a partial cross-sectional view of an exemplary face down type electroless fluid processing cell, in accordance with an embodiment of the invention.

### DETAILED DESCRIPTION OF THE INVENTION

The words and phrases used herein should be given their ordinary and customary meaning in the art to one skilled in the art unless otherwise further defined. Electroless deposition is broadly defined herein as deposition of a conductive material generally provided as charged ions in a bath over a catalytically active surface to deposit the conductive material by chemical reduction in the absence of an external electric current.

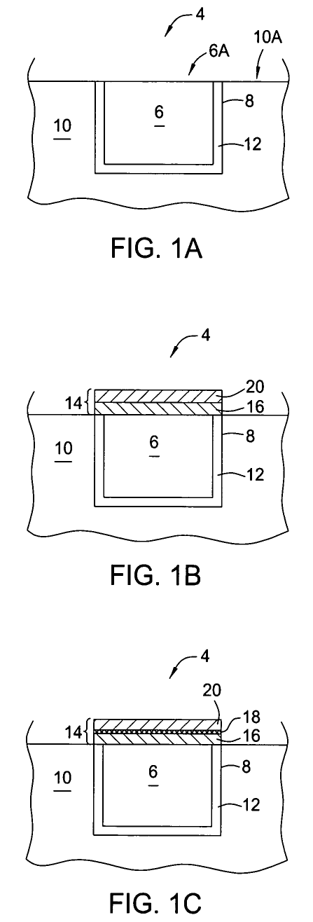

FIG. 1A illustrates a cross-sectional view of an interconnect 4 containing a conductive fill material 6 disposed within an interconnect opening 8 formed in a dielectric material 10. In one embodiment, the dielectric material 10 is a low-k dielectric material, such as, a Black Diamond™ film, available from Applied Materials, Inc. of Santa Clara, Calif.; CORAL™ film, available from Novellus Systems Inc. of San Jose, Calif., AURORATM film available from ASM International of Bilthoven, Netherlands; organosilanes or organosiloxanes; spin on dielectrics; carbon doped oxides; silicates; and any other suitable material. Interconnect 4, as well as other semiconductor features, are disposed on a substrate. Substrates on which embodiments of the invention may be useful include, but are not limited to, crystalline silicon (e.g., Si<100>or Si<111>), silicon oxide, silicon germanium, doped or undoped polysilicon, doped or undoped silicon, and silicon nitride. Other substrates may include bare silicon wafers, or substrates having conductive or non-conductive layers thereon, such as layers comprising materials having dielectric, conductive, or barrier properties, including aluminum oxide and polysilicon, and pretreated surfaces. Pretreatment of surfaces may include one or more of polishing (e.g., CMP, electro-polishing), patterning, etching, reduction, oxidation, hydroxylation, annealing and baking. The term substrate surface is used herein to include any semiconductor feature, including the exposed surfaces of interconnect features, such as the top, bottom, and/or side walls of vias, lines, dual damascenes, contacts and the like.

Multiple electronic device features, such as, trenches and holes, may be formed in the dielectric material 10. A liner barrier layer 12 is used to separate the dielectric material 10 from the conductive fill material 6. Liner barrier layer 12 may include materials such as titanium, titanium nitride, tantalum, tantalum nitride, tantalum silicon nitride, tungsten nitride, silicon nitride, and combinations thereof which are usually deposited by physical vapor deposition (PVD), atomic layer deposition (ALD), and chemical vapor deposition (CVD) techniques. Conductive fill material 6 includes metals such as copper (Cu), aluminum (Al), tungsten (W), and various alloys of the aforementioned metals, and preferably, the conductive fill material 6 is Cu or Cu alloy for forming the interconnect 4 structure (e.g., line or via). The conductive fill material 6 is generally deposited by a deposition process, such as electroplating, electroless plating, CVD, PVD, ALD, and/or combinations thereof. A layer of conductive fill material is deposited and then polished or leveled, by techniques such as electrochemical polishing and/or CMP, to form the interconnect 4 structure depicted in FIG. 1A, having a conductive surface 6A and dielectric surface 10A. The conductive surface 6A is generally defined as the surface of the filled trenches and holes containing the conductive material 6 and the liner barrier layer 12 that have been exposed after the CMP process. After polishing, the dielectric surface 10A is typically cleaned to remove polishing residue and other contaminants.

FIG. 1B illustrates a cross-sectional view of the interconnect 4 shown in FIG. 1A that has a first layer 16 and a second layer 20 which have been electrolessly deposited onto the conductive surface 6A using the embodiments described herein. Embodiments described herein may be adapted to electrolessly deposit one or more layers onto a conductive surface of the substrate having a constant or varying chemical composition in different regions of each of the deposited layers. Formation of two or more layers on the conductive surface 6A may have advantage since each deposited layer can have differing properties which when placed together will form a layer that has improved properties over a single deposited layer. For example, in one case a the first layer may adhere well to the conductive surface 6A, but have poor oxidation resistance and a second layer may have poor adhesion but good oxidation resistance, so that when the two layers are deposited on top of each other the combined layers (i.e., item 14) have good adhesion and good oxidation resistance. Typical properties that may be useful when forming a film stack 14 may be, for example, improved adhesion to the conductive surface, improved electromigration resistance results, improved diffusion barrier properties, improved surface diffusion resistance, improved oxidation resistance of the exposed surface(s), and an improved barrier to oxygen diffusion, to name just a few characteristics. In one example of a film stack 14, a first layer formed over a copper (Cu) conductive surface that contains cobalt (Co), tungsten (W), phosphorus (P) and boron (B) and a second layer formed on the first layer containing a cobalt (Co) and boron (B), or cobalt (Co) and phosphorus (P) has proven advantageous. The multilayer stack containing Cu/CoWPB/CoP, or Cu/CoWPB/CoB, has shown advantageous properties over a single COWPB layer deposited over a copper surface. The COWPB film has excellent barrier and electromigration resistance properties, but poor oxidation resistance properties. However, when a second layer containing CoP or CoB is deposited on top of the Cu/CoWPB stack the mutilayer structure has shown improved oxidation resistance, along with good electromigration resistance and barrier properties found when using the single COWPB layer. In this case the thickness of the first layer 16 or the second layer 20 may vary between about 1 angstrom (Å) and about 1,000 Å, but is preferably between about 1 Å and about 100 Å.

FIG. 1C. illustrates a cross-sectional view of the interconnect 4 shown in FIG. 1A that has a first layer 16, a transition layer 18 and a second layer 20 that have been electrolessly deposited onto the conductive surface 6A using the embodiments described herein. In this configuration the concentration of the various electroless plating chemicals were varied towards the end of the first layer deposition process and the start of the second layer deposition process to form the transition layer 18 which contains a decreasing concentration of the first layer 16 elements and an increasing concentration of the second layer 20 elements as one moves away from the conductive surface 6A. The transition layer 18 can range from a couple monolayers to tens or hundreds of angstroms if desired. This configuration may be useful since it can achieve optimum adhesion, electromigration and copper diffusion resistance together with oxidation resistance without the additional cost and complexity, and topography associated with performing two consecutive depositions in a conventional fashion. However, the mutual compatibility of the processing solutions is needed in this configuration to assure repeatable process results.

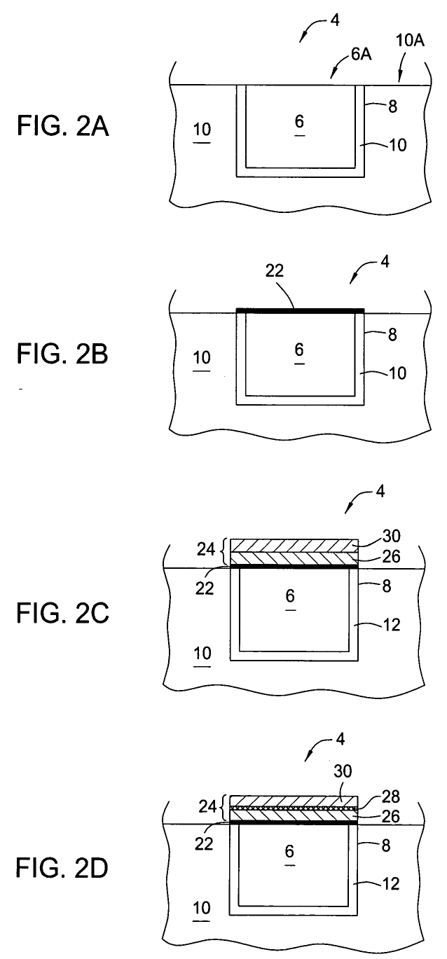

FIG. 2A illustrates a cross-sectional view of an interconnect 4 containing a conductive fill material 6 disposed within an interconnect opening 8 formed in a dielectric material 10, as shown in FIG. 1A.

FIG. 2B illustrates a cross-sectional view of the interconnect 4 shown in FIG. 2A that has an activation layer 22 which has been deposited onto the conductive surface 6A. The activation layer 22 may be used to increase adhesion and selectivity of the subsequent film stack 24 deposited over the Cu interconnect. In one aspect, the activation layer 22 is deposited by displacement plating using an activation solution containing at least one noble metal salt and at least one acid. A concentration of the noble metal salt within the activating solution should be between about 80 parts per million (ppm) and about 300 ppm. Exemplary noble metal salts include palladium nitrate (Pd(NO₃)₂), palladium chl6ride (PdCl₂), palladium sulfate (PdSO₄), palladium methanesulfonate (Pd(CH₃SO₃)₂), or combinations thereof. A rinsing process using a rinsing agent, such as deionized water, for example, is applied to the substrate surface after forming the activation layer 22 to remove any of the solution used to form the activation layer. In one aspect, the activation layer 22 and rinsing process is completed in the same chamber as the steps used to form the film stack 24 (e.g., process 100 described below). In another aspect, the activation layer 22 and rinse process are performed in another chamber, after which the substrate is transferred to a process chamber in which the film stack 24 deposition process(es) are completed.

FIG. 2C. illustrates a cross-sectional view of the interconnect 4 shown in FIG. 2B that has a first layer 26 and a second layer 30 that have been electrolessly deposited onto the activation layer 22 formed on the conductive surface 6A using the embodiments described herein. Embodiments described herein may be adapted to electrolessly deposit one or more layers onto the activation layer 22 having a constant or varying chemical composition in different regions of each of the electrolessly deposited layers. Formation of two or more layers on the activation layer 22 may have advantage since each deposited layers can have differing properties which when placed together will form a layer that has improved properties over a single deposited layer. In this configuration the thickness of the first layer 26 or the second layer 30 may vary between about 1 angstrom (Å) and about 1,000 Å, but is preferably between about 1 Åand about 100 Å.

FIG. 2D illustrates a cross-sectional view of the interconnect 4 shown in FIG. 2B that has a first layer 26, a transition layer 28 and a second layer 30 that have been electrolessly deposited onto the activation layer 22 using the embodiments described herein. In this configuration the concentration of the various chemicals may be varied as a function of time to form the transition layer 28 which contains a decreasing concentration of the first layer 26 elements and an increasing concentration of the second layer 30 elements as one moves away from the activation layer 22. The transition layer 28 can range from a couple monolayers to tens or hundreds of angstroms if desired. This configuration may be useful since it can increase adhesion of the layers and improve some of the properties of the film stack 24.

Processing Steps

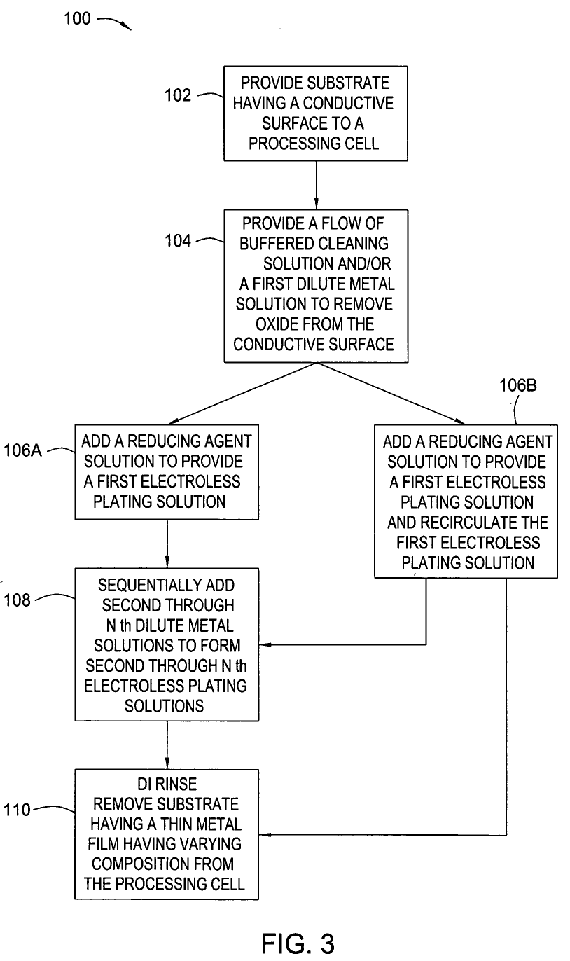

Process 100, shown in FIG. 3, generally describes an electroless deposition process that is used to clean the conductive surface 6A and then electrolessly depositing a thin metal film having discrete or varying composition onto the conductive surface 6A using a single processing cell, in accordance with various embodiments of the invention. The process 100 advantageously includes in-situ cleaning step in order to minimize the formation of oxides on the conductive surfaces 6A, by minimizing or preventing the exposure of the conductive surfaces 6A to oxygen (e.g., air) between the cleaning step and an electroless deposition process step(s).

In one aspect of process 100, the chemical components (e.g., metal solutions 2450a-n, reducing agent solutions 460a-n, DI water 414, and buffered cleaning solution concentrate 440 discussed below) used to deposit the one or more electroless layers are selected so that the interaction of various chemical components will not drastically change the desirable properties of each of the interacting fluids, generate particles in the fluid lines or on the surface of the substrate, and/or generate a significant amount of heat which can damage the hardware or significantly change the electroless process results. In another aspect of the process 100, no rinsing steps are required between the various deposition steps used to form the various layers, since the processing fluids are selected so that they are compatible with each other. This is advantageous since additional rinsing steps will increase the chamber processing time and increase the likelihood of contamination or oxide formation on the conductive surfaces 6A or other deposited layers.

In another aspect, throughout the process 100 the conductive surfaces 6A are continually in contact with various chemical components that will inhibit oxidation of the conductive surfaces and/or reduce the oxidized metal surfaces. This configuration may be achieved by first cleaning the surface of the substrate using a buffered cleaning solution and then assuring that the conductive surfaces are in continuous contact with one or more cleaning and/or reducing agents that thus will prevent the growth of unwanted metal oxides throughout all phases of the electroless process. The term continuous process, or continuous electroless deposition process, is thus used to broadly describe an electroless deposition process where a surface of a substrate is in uninterrupted contact with one or more processing solutions, such that, at any given time the processing solution in contact with the substrate surface contains at least one component that inhibits oxidation of the conductive surfaces and/or reduces the oxidized surface species.

Process 100 is generally performed by delivering various fluid processing solutions to the substrate surface so that each of the fluid processing solutions can interact with the substrate surface to complete a desired processing step. Process 100 generally contains two or more of the following processing steps: a surface wetting or cleaning process step 104, an electroless deposition process step 106A (or 106B) to form a first electrolessly deposited layer, a second electroless processing step 108 to deposit the second through n^{th} electrolessly deposited layers on the surface of the substrate, and a rinse step 110. In one embodiment, the fluid processing solutions used in the processing steps 104-108, contain four main types of component solutions that are added together, in user defined ratios, to form one or more desired fluid processing solutions that are used to complete the processing steps 104-108. The four main types of component solutions include: a buffered cleaning solution, a metal solution, a buffered reducing agent solution and DI water. In general, while there are four main types of component solutions, each type may have many different sub-types of the component solutions that contain different concentrations of the chemical components, and/or have different chemical components added to it so that a desired processing characteristic can be achieved during the process 100 processing step(s).

In one embodiment, the buffered cleaning solution, metal solution and/or buffered reducing agent solution are added to the DI water component to form a more dilute fluid processing solution. In one aspect, it may be desirable to add the component solutions to a degassed and heated DI water to improve the process results. Diluting the various component solutions may be advantageous since it may help to reduce the waste of the often expensive chemical components, improves process results, and increases the time between having to replace the containers of the various component solutions. In one aspect, it may be desirable to dilute the component solutions to form a fluid processing solution in a ratio of about 2:1:1:1 to about 13:1:1:1, where the ratio is defined as DI water to buffered cleaning solution to metal solution to buffered reducing agent solution. Preferably, the mixing ratio is in a range between about 6:1:1:1 and about 9:1:1:1 (e.g., DI water:buffered cleaning solution:metal solution:buffered reducing agent solution).

Unless otherwise specified, the concentration of each of the component solutions described below in conjunction with each of the process 100 processing steps is intended to describe the component solution in its undiluted form (e.g., prior to mixing with other components solutions).

Process Step 102

Forming a thin metal layer having varying composition generally begins with transferring a substrate having a conductive surface 6A to a processing cell at step 102. For illustrative purposes, process 100 will be applied to the formation of a thin metal capping layer having varying composition over a conductive Cu interconnect.

Process Step 104

In one embodiment, at step 104, a first processing fluid, which contains DI water, a buffered cleaning solution and/or a first metal solution, is delivered to the substrate surface for wetting, cleaning and thermally equilibrating the substrate having a Cu interconnect surface. The temperature of the first processing fluid may be between about 50° C. and about 75° C. The combination of the buffered cleaning solution and first metal solution to the DI water may provide cleaning and removal of oxides while precoordinating or preabsorbing the metal ions to the clean conductive surface 6A. The buffered cleaning solution is generally an aqueous solution containing chelating, complexing, and buffering agents and/or a pH adjuster. In one embodiment, the buffered cleaning solution may be optionally included as a component of the electroless bath solutions. In this embodiment, the buffered cleaning solution preferably includes, in addition to cleaning and buffering components, a chelating agent that used to complex the metal ions (e.g., Co) to enhance stability and control of the deposition rate. Such chelating agents include carboxylic acids and other non-oxidizing acids. Preferable acids include acetic acid (C₂H₄O₂), lactic acid (C₃H₆O₃), citric acid (C₆H₈O₇), and/or combinations and derivatives thereof. The salt of the neutralized acid may have a concentration in a range from about 0.25 Molar (M) to about 0.5 M, preferably about 0.38 M.

An additional complexing agent is generally selected so as to promote non-selective removal of different oxidation states of metal oxides (e.g., copper oxides) formed on the conductive surface 6A. In particular, the complexing agent is selected so as to promote effective removal of metal oxides (e.g., cupric and cuprous ions) at a preferred process pH without substantially inhibiting the electroless deposition process by complexing with the metal ions (e.g., Co ions or W ions) in electroless plating solution. Examples of preferable complexing agents include amino acids, such as glycine (C₂H₅NO₂). The complexing agent may have a concentration in the plating solution ranging from about 0.1 M to about 0.5 M, preferably about 0.38 M.

Basic buffering agents which may also exhibit complexation to metal ions include amines, ammonia, amino compounds, diamino compounds, and polyamino compounds. Preferable basic buffering agents include diethanolamine ((HOCH₂CH₂)₂NH; DEA), triethanolamine ((HOCH₂CH₂)₃N; TEA), ethanolamine ((HOCH₂CH₂)NH₂), ethylenediaminetetraacetic acid (C₁₀H₁₆N₂O₈; EDTA), derivatives thereof and combinations thereof. Compounds specifically selected to exhibit pH buffering and improve wetting properties include TEA and DEA. While the use of ammonia is not precluded, much less volatile (high molecular weight) amines, such as TEA and DEA are preferred both for improved pH stability and reduced tendency to diffuse into low-k dielectric materials. This buffering agent may have a concentration in a range from about 0.5 M to about 1.5 M, preferably about 1.15 M.

A pH adjusting agent, generally a base, is used to adjust the pH of the buffered cleaning solution to a pH in a range from about 8 and about 10, preferably between about 9.0 and about 9.5. Suitable pH adjusting agents include amines and hydroxides, such as DEA, TEA, tetramethylammonium hydroxide ((CH₃)₄NOH; TMAH), ammonium hydroxide (NH₄OH), derivatives thereof and combinations thereof.

In one example, a buffered cleaning solution includes about 75 g/L glycine, about 54 g/L sulfuric acid, about 30 g/L acetic acid, about 52 g/L DEA, deionize (DI) water, and an amount of TMAH (25% by weight) sufficient to adjust the pH to about 9.25. This buffered cleaning solution may be prepared by adding the 54 grams (g) of concentrated sulfuric acid to about 300 milliliters (ml) of DI water in a magnetically stirred 1 Liter (L) graduated beaker and allowing the mixture to cool to room temperature. In a separate beaker, add about 30 g of concentrated acetic acid to about 350 ml DI water while stirring. Weigh about 52 g of DEA in a 100 ml plastic bottle and add the DEA to the 1 L graduated beaker containing dilute sulfuric acid while stirring. Extract remaining DEA in the 100 ml plastic bottle by using a portion of the sulfuric acid-DEA solution and subsequently rinsing with DI water to provide a total volume of about 500 ml in the 1 L beaker. Titrate the sulfuric acid-DEA solution with TMAH (25%) to adjust the pH to about 7.0. Next, add about 75 g glycine and the dilute acetic acid to the 1 L beaker containing the sulfuric acid-DEA-TMAH solution, and then titrate with TMAH (25%) to a pH of about 9.25. Then dilute to a final volume of 1000 ml with DI water. In another example, one liter of a buffered cleaning solution includes about 15 g/L glycine, about 10.5 g/L DEA, DI water, and an amount of acetic acid sufficient to adjust the pH to about 9.25. In another example, a buffered cleaning solution may contain about 22.4 g/L glycine, about 120.9 g/L DEA, 72 g/L citric acid, 6.2 g/L boric acid, DI water, and an amount of TMAH (25%) sufficient to adjust the pH to about 9.25.

In an example of electrolessly depositing a capping layer over a Cu interconnect, the first metal solution may include one or more metals selected from a group consisting of Co, W, nickel (Ni), tungsten (W), molybdenum (Mo), rhenium (Re), ruthenium (Ru), platinum (Pt), palladium (Pd), tin (Sn), and combinations thereof.

In one example, the first metal solution generally comprises a cobalt source, a tungsten source, a complexing agent, a pH adjusting agent and water. The cobalt source may be in a concentration range from about 0.05 M to about 0.15 M, preferably about 0.10 M. The cobalt source can include any water soluble cobalt precursor (e.g., Co²⁺), for example cobalt sulfate (CoSO₄), cobalt chloride (CoCl₂), cobalt acetate ((CH₃CO₂)₂Co), derivatives thereof, hydrates thereof and combinations thereof. Some cobalt sources are commonly available as hydrate derivatives, such as CoSO₄.7H₂O, CoCl₂.6H₂O and (CH₃CO₂)₂Co.4H₂O. In one embodiment, cobalt sulfate is the preferred cobalt source. For example, CoSO₄.7H₂O may be present in a concentration of about 0.10 M.

In one example, the first solution also contains a tungsten source that may be in a concentration range from about 0.01 M to about 0.08 M, preferably from about 0.03 M to about 0.05 M. The tungsten source may include tungstic acid (H₂WO₄) and various tungstate salts, such as ammonium tungstate ((NH₄)₂WO₄), cobalt tungstate (COWO₄), sodium tungstate (Na₂WO₄), potassium tungstate (K₂WO₄), other WO₄²⁻ sources, derivatives thereof and/or combinations thereof. In one example, tungstic acid is the preferred tungsten precursor. For example, tungstic acid may be present in a concentration of about 0.04 M.

A complexing agent is also present in the CoW solution that may have a concentration range from about 0.1 M to about 0.6 M, preferably from about 0.2 M to about 0.4 M. In the CoW solution, complexing agents or chelators form complexes with cobalt sources (e.g., Co²⁺). Complexing agents may also provide buffering characteristics in the CoW solution. Complexing agents generally may have functional groups, such as amino acids, carboxylic acids, dicarboxylic acids, polycarboxylic acids, amines, diamines and polyamines. Complexing agents may include citric acid, glycine, amino acids, ethylene diamine (EDA), ethylene diamine tetraacetic acid (EDTA), derivatives thereof, salts thereof and combinations thereof. In one embodiment, citric acid is the preferred complexing agent. For example, citric acid may be present in a concentration of about 0.25 M to about 0.5 M.

Also, an optional surfactant may be added to any one of the component solutions. The surfactant acts as a wetting agent to reduce the surface tension between the plating solution and the substrate surface. Surfactants are generally added to the metal solution at a concentration of about 1,000 ppm or less, preferably about 500 ppm or less, such as from about 100 ppm to about 300 ppm. The surfactant may have ionic or non-ionic characteristics. A preferred surfactant includes dodecyl sulfates, such as sodium dodecyl sulfate (SDS). Other surfactants that may be used in the cobalt-containing solution include glycol ether based surfactants (e.g., polyethylene glycol). For example, a glycol ether based surfactants may contain polyoxyethylene units, such as TRITON® 100, available from Dow Chemical Company. The surfactants may be single compounds or a mixture of compounds of molecules containing varying length of hydrocarbon chains.

A pH adjusting agent, generally a base, is used to adjust the pH of the first metal solution to a pH in a range from about 7 and about 12, preferably from about 8 to about 10. Suitable pH adjusting agents include hydroxides, such as tetramethylammonium hydroxide ((CH₃)₄NOH; TMAH), ammonium hydroxide (NH₄OH), derivatives thereof and combinations thereof. For example, TMAH may be present to adjust the pH of each solution to a pH of about 9 to about 9.5.

In one example, a first metal solution includes about 28 g/L cobalt sulfate (CoSO₄.7H₂O), about 10 g/L tungstic acid, about 57.5 g/L citric acid, DI water, and an amount of TMAH (25%) sufficient to adjust the pH to about 9.25. This first metal solution may be prepared by dissolving 10 g of tungstic acid (preferably obtained from Alfa Aesar®, located in Ward Hill, Mass.) in about 300 ml of DI water in a 500 ml graduated beaker and add about 20 ml of 25% TMAH. Heat the 500 ml mixture on a hot plate to a temperature in the range from about 35° C. to about 100° C. for at least 10 minutes until dissolution appears complete. While heating, additional TMAH may be added if necessary, preferably without exceeding a pH of about 10, and DI water may be added to replace any evaporated water. Then decant a clear liquid mixture to separate the clear solution from any residual particulates or material (specs) that may have settle to the bottom of the 500 ml beaker. In a separate 1 L graduated plastic mixing beaker, add about 28 g cobalt sulfate and about 57.5 g/L citric acid to about 250 ml DI water. Titrate the cobalt-citric acid aqueous solution with TMAH to a pH of about 7, and then add the clear tungstic acid-TMAH aqueous solution while stirring. Titrate the solution with TMAH to a pH of about 9.25 and dilute with DI water to a final volume of 1000 ml. In another example, one liter of a first metal solution may include about 57.5 g/L citric acid, about 5.5 g/L sulfuric acid, about 22.5 g/L CoSO₄.7H₂O, about 5.0 g/L CoCl₂.6H₂O, about 10 g/L tungstic acid, DI water, and an amount of TMAH (25%) sufficient to adjust the pH to about 9.25. In another example, one liter of a first metal solution may include about 74 g/L citric acid, about 24 g/L CoCi₂.6H₂O, about 5 g/L tungstic acid, about 0.2 g/l SDS (a surfactant), DI water, and an amount of TMAH (25%) sufficient to adjust the pH to about 9.25.

In another example of the first metal solution contains only a cobalt source, a complexing agent, a pH adjusting agent and water. The cobalt solution includes a cobalt source that may be in a concentration range from about 0.05 M to about 0.15 M, preferably about 0.10 M. The cobalt source can include any water soluble cobalt source (e.g., Co²⁺), for example cobalt sulfate (CoSO₄), cobalt chloride (CoCl₂), cobalt acetate ((CH₃CO₂)₂Co), hydrates thereof and combinations and derivatives thereof. The pH adjusting agents, as described above, may include hydroxides, such as tetramethylammonium hydroxide ((CH₃)₄NOH; TMAH), ammonium hydroxide (NH₄OH), derivatives thereof and combinations thereof. The complexing agents used in this solution generally may have functional groups, such as amino acids, carboxylic acids, dicarboxylic acids, polycarboxylic acids, amines, diamines and polyamines.

In one embodiment of process step 104, the first processing fluid contains a buffered cleaning solution and no first metal solution. In this configuration the first processing solution may be delivered at a temperature in the range of about 50° C. to about 75° C. to wet, clean and thermally equilibrate the surface of the substrate. The buffered cleaning solution, as described above, may generally contain an aqueous solution comprising an acid, a complexing agent, a buffering agent and/or a pH adjuster.

Process Step 106A

At step 106A, after treating the substrate surface first with at least the buffered cleaning solution, a buffered reducing agent solution is added to a flow containing the buffered cleaning solution and the first metal solution thereby forming a first electroless plating solution. The first electroless plating solution, which includes the first metal solution and the first reducing agent solution, electrolessly deposits a first metal layer, for example, CoWP, CoWPB, CoP or CoB onto the Cu interconnect surface. The buffered reducing agent solution may be essentially any compatible reducing agent solution. In a preferred embodiment, the first buffered reducing agent solution includes an electroless plating solution which is self-initiating. In one aspect, the electroless deposition of a first metal layer over a conductive surface 6A is completed without the aid of an activation layer (see FIGS. 2A-D) or other activating surface pretreatment of the conductive surface 6A. In another aspect, the electroless deposition process is performed by first forming an activation layer and then electrolessly depositing a metal layer onto the activation layer.

The buffered reducing agent solution may contain a phosphorous source and/or boron source, a pH adjusting agent, water and an activator. A phosphorous source, such as hypophosphite, may be in the buffered reducing solution in a concentration in a range of about 0.1 M to about 0.5 M. The phosphorous source and/or the boron source functions as the reductant throughout the plating process that chemically reduces dissolved ions in the plating solution and also provides elemental phosphorous for incorporation into the deposited metal alloy (e.g., COWP or CoWPB). Hypophosphite sources include hypophosphorous acid (H₃PO₂), salts thereof and combinations thereof. Once dissociated in solution, the hypophosphite source occurs as H₂PO₂¹⁻, with salts including Na¹⁺, K¹⁺, Ca²⁺, NH₄¹⁺, (CH₃)₄N¹⁺and combinations thereof, preferably (CH₃)₄N¹⁺.

An activator, such as a borane-base co-reductant, is added to the above plating solution. Borane-base co-reductants serve as reducing agents as well as elemental sources of boron. As a reducing agent, the co-reductant chemically reduces (i.e., transfers electrons to) dissolved ions in the plating solution to initiate the electroless plating process. The reduction process precipitates the various elements and/or compounds to form the composition of the COWP alloy, such as cobalt, tungsten, phosphorus, amongst other elements. The borane-base co-reductant, upon being oxidized by the dissolved ions, may be incorporated to a small extent as boron in the COWP alloy. Borane-based co-reductants are typically the boron source for COWB and CoB alloys. Borane-based co-reductants and boron-sources include dimethylamine borane complex ((CH₃)₂NH.BH₃), DMAB), trimethylamine borane complex ((CH₃)₃N.BH₃), TMAB), tert-butylamine borane complex (^{t}BuNH₂.BH₃), pyridine borane complex (C₅H₅N.BH₃), ammonia borane complex (NH₃.BH₃), complexes thereof and combinations thereof. A more detailed description of self-activating electroless deposition described herein may be found in the commonly assigned U.S. patent application Ser. No. 10/967,919, entitled “Selective Self-Initiating Electroless Capping Of Copper With Cobalt-Containing Alloys” by Timothy W. Weidman et al., filed Oct. 21, 2004, which is incorporated by reference herein in its entirety to the extent not inconsistent with the claimed aspects and description herein. In one example, the buffered reducing solution may contain DMAB in a concentration in a range of about 0.1 M to about 0.5 M.

A pH adjusting agent, generally a base, may be included to adjust a buffered reducing agent solution to a pH in a range from about 7 to about 12, preferably from about 8 to about 10 and more preferably about 9.5. The pH adjusting agent can include ammonia, amines or hydroxides, such as TMAH, NH₄OH, TEA, DEA, derivatives thereof and combinations thereof. The pH adjusting agent used in the buffered reducing agent solution may be the same or different than the pH adjusting agent used in the CoW solution and buffered cleaning solutions.

An optional stabilizer may also be added to the buffered reducing solution. It is believed that the stabilizers may selectively complex with the dissolved copper ions (e.g., Cu¹⁺or Cu²⁺) and inhibit their tendency to initiate particle growth. Alternately, the stabilizers may inhibit the growth of the reduced metal ions into particles. A useful stabilizer will be water soluble and have a high affinity for complexing copper ions. In the buffered reducing solution, a typical stabilizer may have a concentration from about 20 ppm to about 250 ppm, preferably, from about 80 ppm to about 120 ppm. One preferred stabilizer is hydroxypyridine or derivatives thereof at a concentration of about 80 ppm to about 120 ppm.

In one example, one liter of a buffered reducing agent solution is prepared by adding about 12 g DMAB and about 33 g of 50% H₃PO₂ to DI water at ambient temperature, and then adding 25% TMAH to adjust the pH to about 9.25. In another example, a buffered reducing agent solution may contain about 12 g/L DMAB, 72 g/L of citric acid, 0.1 g/L of hydroxypyridine (a stabilizer), and about 33 g/L of 50% H₃PO₂, DI water, and then adding 25% TMAH to adjust the pH to about 9.25.

Process Step 108

At step 108, after depositing the first metal layer, the flow of the first metal solution is decreased to a flow rate of zero while simultaneously introducing and increasing a flow rate of a second metal solution, so as to maintain a constant combined flow rate. As the first and second metal solution flow rates are adjusted, a very thin interfacial layer having elements from both the first and second metal solutions may be formed over the first metal layer. Forming an interfacial layer may enhance compatibility or adhesion between the first metal layer and a subsequently deposited second metal layer. The addition of the second metal solution provides a second electroless plating solution which includes the second metal solution and the first reducing agent for electrolessly depositing a second metal layer, for example CoFeP on the interfacial layer CoWFeP. Likewise, a flow of a third metal solution, fourth metal solution through an nth metal solution may be sequentially introduced to a flow of a reducing agent such that a third metal layer, fourth metal layer through and n^{th} metal layer is deposited over a conductive surface 6A of a substrate.

The process 100 may be flexibly implemented to electrolessly deposit a series of layers having different compositions and thicknesses. In another embodiment, after depositing the first layer CoWP, the first reducing agent solution may be substituted by, or combined with, a second reducing agent solution. Introducing a flow of a second reducing agent solution may occur in parallel with introducing a second metal solution such that the flow of the first metal solution and first reducing agent solution are decreased as the flow of the second metal solution and the second reducing agent solution are increased. A second electroless plating solution including the second metal solution and the second reducing agent solution electrolessly deposits a second metal layer, for example CoFeB, on an interfacial layer CoWFePB having elements from the first and second metal solutions as well as the first and second reducing agent solutions. Alternatively, in another embodiment, a second reducing agent solution may be introduced just prior to the introduction of a second metal solution. In another embodiment, the flow of the first metal solution may be completely stopped such that the substrate is exposed to the flow of the first reducing agent solution, and/or second reducing agent solution, just prior to introducing the flow of the second metal solution or second electroless plating solution. This technique provides a sharp transition between the first and second metal layers and minimizes the thickness of any interfacial layer. The thickness of each of the electrolessly deposited layers, i.e., first metal layer through a n^{th} metal layer, may be individually controlled by diluting the particular metal solution to have a desired metal concentration and by controlling the amount of time the conductive surface 6A, or a previously deposited metal layer n−1, is exposed to an electroless solution. Each of the electrolessly deposited layers may have a thickness of about 30 Åor more, and preferably a thickness of about 50 Åto about 100 A. The thickness of each of the interfacial layers may be controlled by the amount of time adjusting one or more metal solution flow rates and/or one or more reducing agent solution flow rates. The interfacial layers may have a thickness of about 5 Åor more, and preferably a thickness of about 10 Åto about 50 Å. Providing individual component flow streams of the first through nth metal solutions and the first through n^{th} reducing agent solutions provides flexibility in quickly changing the compositions of the electroless plating solution in a continuous electroless deposition process. The continuous electroless deposition process may provide a film that has a continuous change in film composition or a sharp transition or change in film composition.

The second through n^{th} metal solutions may be prepared in the same manner as the first metal solution as described above. Although the second through n^{th} metal solutions may contain essentially any metal or metal alloy, as described above for the first metal solution, the metal or metal alloy is preferably selected so as to provide the top metal layer, i.e., the n^{th} metal layer, with desirable surface properties, such as oxidation resistance. In an example, for providing a second metal layer resistant to oxidation, a second metal solution may preferably include an oxidation-resistant metal such as gold (Au), silver (Ag), platinum (Pt), palladium (Pd), rhodium (Rh), ruthenium (Ru), osmium (Os), iridium (Ir), and combinations thereof. For example, for forming a Rh noble metal passivation layer over a first metal layer (CoWP), one liter of a second metal solution may contain about 1.0 g/L glycine, 0.5 g/L Rh₂(SO₄)₃(H₂O)₄, and DI water. In one aspect, once the second electroless plating solution is introduced into the processing cell, the second electroless solution may be recirculated to the processing cell in order to provide efficient use of the noble metal (i.e., second metal solution) and minimize waste. The recirculation operation of the processing cell is described in more detail below.

In another embodiment, a second metal layer having magnetic properties is deposited over the first metal layer. For example, for forming a magnetic layer CoFePB over the first metal layer (CoWP), one liter of a second metal solution may contain about 28 g/L CoSO₄.7H₂O, about 28 g/L Fe(SO₄)₂.6H₂O, about 38.5 g/L citric acid, DI water, and an amount of TMAH (25%) sufficient to adjust the pH to about 9.2. Once the second metal solution is introduced into the processing cell, a second electroless plating solution deposits the CoFePB magnetic layer on the CoWP layer or on an interfacial layer CoFeWPB depending upon which technique is used to introduce in the second metal solution.

In another embodiment, a second metal layer containing CoP or CoB is deposited over the first metal layer. For example, for forming a CoB layer over a first metal layer containing CoWPB, one liter of a second metal solution may contain about 24 g/L cobalt sulfate (CoCl₂.6H₂O), about 74.4 g/L citric acid, DI water, and an amount of TMAH (25%) sufficient to adjust the pH to about 9.25. The second reducing agent may contain about 12 g/L DMAB and then adding 25% TMAH to adjust the pH to about 9.25. Once the second metal solution is introduced into the processing cell, a second electroless plating solution deposits the CoB layer on the CoWP layer or on an interfacial layer CoWPB depending upon which technique is used to introduce in the second metal solution.

Process Step 106B

At step 106B, in another embodiment of the invention, the first electroless plating solution formed in step 106A is recirculated to deposit a thin metal layer (e.g., CoWP) having varying composition on a conductive surface 6A. This embodiment employs continuously recirculating the self-activating electroless plating solution to the processing cell to form a thin metal film having a varying composition due to the changing constituent concentrations of the plating solution as the metal or the metal alloy is deposited and simultaneously depleted from the electroless plating solution. One feature of this embodiment is the self-limiting plating or growth of a thin metal layer as a means of controlling film thickness.

In one example, the first electroless plating solution formed in step 106A initially deposits a first metal layer of CoWP onto the clean Cu interconnect surface. The first electroless plating solution is collected and recirculated across the surface of the substrate by use of a collection tank system 549, described below, which is adapted to recirculate a collected electroless plating solution. As the first electroless plating solution is recirculated to the processing cell, the autocatalytic deposition of cobalt proceeds as the dilute concentration of cobalt in solution rapidly depletes such that the relative concentration of W in solution increases and the growing film becomes tungsten rich and catalytically inactive or self-limiting. The continuous self-limiting electroless plating process forms a CoWP film having decreasing amounts of cobalt across the thickness of the film, such that the first layer of the film is a cobalt-rich CoWP layer and the surface of the film is a tungsten-rich CoWP layer which inhibits further growth of the film.

In another embodiment, at step 106B, the first metal solution of the first electroless plating solution described in step 106A is substituted by a second metal solution which is formulated with a very small quantity of metal in order to autocatalytically self-extinguish even more quickly. This embodiment provides an alternative means of controlling film thickness growth. For example, a liter of a second metal solution may contain only about 5 g/L cobalt sulfate (COSO₄.7H₂O), about 10 g/L tungstic acid, about 19 g/L citric acid, DI water, and an amount of TMAH (25%) sufficient to adjust the pH to about 9.25. Film thickness of less than about 150 Åmay be deposited using this self-limiting technique.

Process Step 110

At step 110, after electrolessly depositing a thin metal film having a varying composition, the substrate is rinsed with DI water to remove any remaining buffered cleaning solution and/or electroless plating solution from the surface of the substrate. The substrate may be rinsed for a period from about 5 seconds to about 60 seconds, preferably for about 15 seconds.

Fluid Delivery Hardware

The processes described herein are performed in a processing cell generally configured to expose a substrate to an electroless plating solution, wherein the substrate is in a face-down or a face-up configuration. An electroless fluid plumbing system 402 may be used to provide a continuous series of processing solutions to the processing cell for cleaning and electrolessly depositing a series of layers to form a thin metal film having varying composition on a conductive surface 6A, according to various embodiments of the invention.

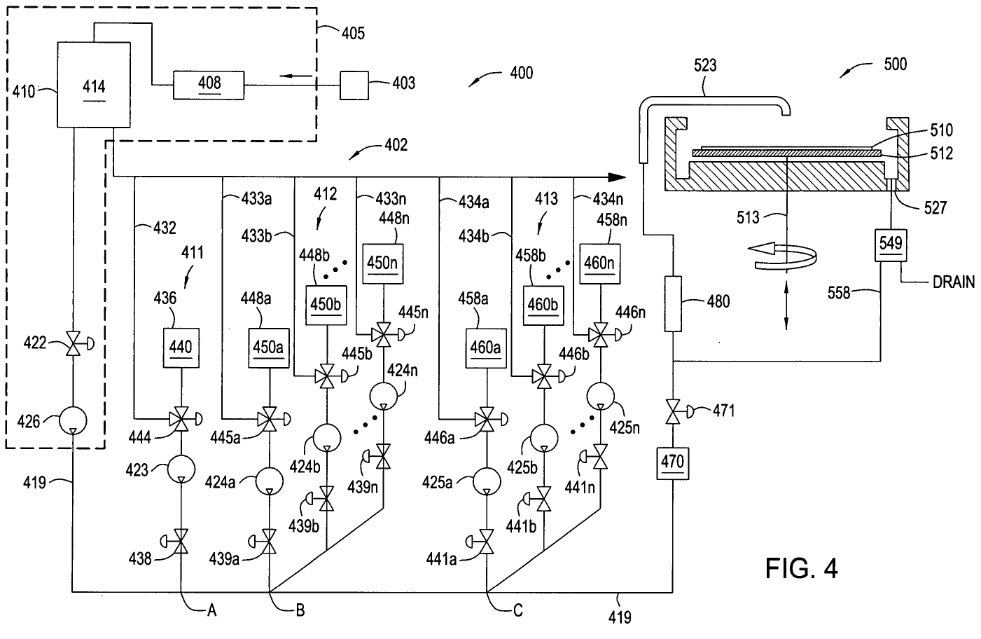

FIG. 4 generally illustrates a schematic view of an exemplary electroless plating system 400 configured to remove oxides from a conductive surface 6A and subsequently deposit a thin metal layer having a varying composition on the conductive surface 6A in one continuous process. The electroless plating system 400 includes an electroless fluid plumbing system 402 configured to provide a continuous flow of a degassed and preheated DI water, buffered cleaning solution, and a series of electroless processing solutions to a processing cell 500 containing a substrate 510 mounted on a substrate support 512. In one embodiment, as shown in FIG. 4, the processing cell is a face-up type processing cell. In one embodiment, the electroless fluid plumbing system 402 generally contains a DI water source system 405, a buffered cleaning solution system 411, a metal solution delivery system 412, and a reducing agent solution delivery system 413. In general, the DI water source system 405, buffered cleaning solution system 411, metal solution delivery system 412, and reducing agent solution delivery system 413 each contain a container (e.g., items 410, 436, 448a-n, and 458a-n), and a fluid metering device (e.g., items 423, 426, 424a-n, and 425a-n). The container is generally a vessel that contains an amount of a desired solution that will mixed with the other components to form one of the processing solution described above. The fluid metering device may be a metering pump, liquid flow controller, or needle valve that is used to control the flow rate of a desired component from the container so that it can be mixed with a known flow rate of other components to form a desired electroless processing solution. In some configurations it may be advantageous to use gravity or pressurize one or more of the containers with a gas to help control the flow of the contained fluid. In one aspect, the fluid metering device is used to dose an amount of a desired component. The timing, flow rate, and dose amount of each of the components is controlled by use of a system controller (not shown) which controls the various components in the electroless fluid plumbing system 402 (e.g., fluid metering devices, isolation valves, etc.). The system controller, which is typically a microprocessor-based controller, is configured to receive inputs from a user and/or various sensors in electroless plating system 400 and appropriately control the processing chamber components and electroless fluid plumbing system 402 in accordance with the various inputs and software instructions retained in the controller's memory (not shown). In another aspect of the invention, as shown in FIG. 4, isolation valves (e.g., items 438, 439a-n, and 441a-n) may be added to prevent cross contamination of the fluids retained in the various containers.

In one embodiment, the DI water source system 405 generally contains a water container 410, an in-line degasser 408, a fluid metering device 426 and an isolation valve 422. During operation, a degassed and preheated DI water 414 is prepared by flowing DI water from the DI water source 403 through an in-line degasser 408 to a water container 410 having a heating source. The degassed and preheated DI water 414 serves as both a diluent and a heat source in forming the buffered cleaning solution and/or electroless processing solutions. Passing the DI water through the in-line degasser 408 reduces the amount of dissolved oxygen (O₂) normally present in the DI water. The in-line degasser 408 is preferably a contact membrane degasser, although other degassing processes including sonication, heating, bubbling inert gas (e.g., N₂ or Ar), adding oxygen scavengers and combinations thereof, may be used. Membrane contactor systems typically involve the use of microporous hollow hydrophobic fibers, generally made from polypropylene, that selectively allow gas diffusion (e.g., O₂) while not permitting liquids to pass. The water container 410 may have a heating source (not shown) which heats the DI water 414 to a temperature in the range of about 50° C. to about 95° C. The heating source may also be a microwave heating source external to the water container 410 (a nonmetallic container), an immersed resistive heating element inside the water tank, a resistive heating element surrounding the water tank, a fluid heat-exchanger that is configured to exchange heat with the DI water by use of a heat exchanging body and a temperature controlled fluid flowed therethrough, and/or another method of heating known to heat water. In addition, the degassed and preheated DI water 414 may be hydrogenated prior to use. Saturation of the DI water 414 is preferably saturated with hydrogen gas may reduce the initiation time of the electroless deposition process. Hydrogenation of the DI water may be completed by bubbling hydrogen gas through the DI water 414, forcing hydrogen gas into DI water 414 while contained in water container 410, and/or by injecting hydrogen into the DI water by use of a contact membrane degasser (not shown).

A flow of a buffered cleaning solution is provided to the processing cell 500 by combining DI water 414 and a buffered cleaning solution concentrate 440 stored in container 436. To form the buffered cleaning solution of a desired concentration, a metered flow of DI water 414 is delivered to insulated line 419 from the water container 410 by use of the fluid metering device 426, and a metered flow of a buffered cleaning solution concentrate 440 is injected into the insulated line 419 at point “A”, by use of the fluid metering device 423, to form a flow of buffered cleaning solution at a desired concentrations at a desired temperature, and at a desired flow rate.

To form a first processing solution, containing a buffered cleaning solution and a first metal solution, as described in step 104, a metered flow of a first metal solution is added to the flowing buffered cleaning solution in the insulated line 419 at about point B. The first metal solution 450a stored in container 448a is metered into the insulated line 419 at about point B, by use of a fluid metering device 424a, where the first metal solution is fed into the flow of buffered cleaning solution concentrate 440 and DI water 414 to form a the buffered cleaning solution and a first metal solution described as described in step 104 that has a desired concentration of the various components, at a desired temperature, and at a desired flow rate. The combined flow of buffered cleaning solution and first metal solution has a flow rate in the range of about 100 ml/min to about 800 mL/min and is delivered to the processing cell 500 for a period of about 5 seconds to about 30 seconds to remove the oxides from the conductive surface 6A. In one aspect, the concentration and types of buffered cleaning solutions and first metal solutions can be varied as desired by varying the flow rate of the various metal solutions 450a through 450n, DI water 414, and buffered cleaning solutions concentrate 440.

To form an electroless plating solution, as described in step 106A (or initially in step 106B) a flow of a first reducing agent solution is added to the combined flow of buffered cleaning solution and first metal solution in insulated line 419 at about point C. to deliver a first electroless bath solution to the processing cell 500. In one embodiment, as the flow of the first reducing agent solution is introduced and the total (or combined) flow rate is increased, the flow DI water is decreased so that the total flow rate and temperature will remain constant. The first reducing agent solution is deliver at a desired flow rate to the insulated line 419 at about point C. by use of the fluid metering device 425 (e.g., one or more of the items 425a-n) thereby forming a flow of a first electroless plating solution. The flow of the first electroless plating solution comprising the buffered cleaning solution, the first metal solution, the first reducing agent solution and DI water 414, typically has a flow rate in the range of about 100 ml/min to about 1000 mL/min and is delivered to the processing cell 500 for a period of about 5 seconds to about 60 seconds to plate a fist metal layer on the conductive surface 6A of the substrate 510. The flow of the first electroless plating solution is preferably delivered to the processing cell 500 via an in-line mixer 470 and an in-line heater 480. In-line heating may be accomplished by jacketing the fluid lines with a flowing heat exchanging fluid or by using an in-line microwave heater such as a microwave cavity.

In one aspect, subsequent metal layers can be formed by varying the flow rate of metal solutions 450a through 45n, reducing agent solutions 460a through 46n, DI water 414, and buffered cleaning solution concentrate 440 to provide a series of electroless plating solutions to the processing cell 500 for depositing a series of metal layers over the conductive surface 6A.

In one embodiment, to assure that the concentration of the various components flowing in the insulated line 419 to the substrate 510 will not vary as one or more chemical components are phased out of the flowing fluid, for example where it is desired to change the composition of the electrolessly deposited layer, it may be necessary to add a fluid into the flowing fluid in proportion to the flow of the phased out component(s). In other words, for example, if it is desirable to phase “out” a 50 mL/min flow of the first metal solution 450a, then a 50 mL/min flow of DI water is phased “in” to assure that the total flow in the insulated line 419 does not change and the proportions of the components already flowing in the line are not changed. Referring to FIG. 4, this process. may be accomplished by use of the three-way valves (e.g., items 444, 445a-n, and 446a-n) connected DI water lines (e.g., items 432, 433a-n, and 434a-n) and the fluid metering device (e.g., items 423, 424a-n, and 425a-n). When in use the three-way valve is used to switch between a container and its associated DI water line, so that the fluid metering device is able to deliver a flow of DI water at the same rate as the previous flow of the fluid delivered from the container.

In one aspect, the three-way valves (e.g., items 444, 445a-n, and 446a-n) connected DI water lines (e.g., items 432, 433a-n, and 434a-n) and the fluid metering device (e.g., items 423, 424a-n, and 425a-n) may be used together to provide an intermediate dilution or rinsing step before the introduction of a new component solution into the insulated line 419.

Substrate to Substrate Process Control

In another aspect, the concentration of the electroless plating solution(s) used to perform the electroless deposition process are varied from one substrate to another substrate to account for changes in the density, surface area, or shape of the conductive surfaces 6A found on the substrate surface. The process can be adjusted based on user input or automated inspection data collected regarding the conductive surface 6A characteristics. Automated inspection tools may include pattern wafer optical wafer inspection tools, Boxer Cross, and SEM-EDX techniques that are adapted to collect information regarding the surface of the substrate.

Based on the collected data the system controller is adapted to adjust the various processing chemistries by commands from one or more process recipes contained in the memory of the system controller. The concentrations of the various processing chemistries may be varied by controlling the flow rate of metal solutions 450a through 45n, reducing agent solutions 460a through 46n, DI water 414, and buffered cleaning solution concentrate 440 to provide a series of cleaning and electroless plating solutions to the processing cell 500 for depositing a layer having desired properties over the conductive surface 6A. For example, in order to maximize the efficiency of cobalt utilization (and minimize amount of cobalt in waste streams) the concentration of cobalt in the processing chemistries may be reduced when the ratio of the copper surface area to the dielectric surface area is smaller than another case where the ratio of the copper surface area to the dielectric surface area is higher.

Ratios of individual components and or levels of a specific additive such as a stabilizer may also be varied during the growth of an electroless coating either to enhance or eliminate an observed dependence of growth rate on pattern size and density. For example, while it is generally desirable to initiate film growth using a formulation established to promote rapid initiation and growth on all exposed surfaces, once the process has initiated the concentration of critical components may be adjusted (by changing the relative mixing ratios of component solutions) to enhance or inhibit deposition on small isolated features relative to larger features. An isolated feature is a feature that is in a region on the surface of the substrate where density of the conductive surfaces is low (e.g., low ratio of copper surface area to the dielectric surface area). Plating formulations exhibiting diffusion limited plating rates, which may be tied to the concentration of a single dilute component (e.g., the concentration of a metal ions), will generally exhibit substantially faster growth over isolated features when plated using a static puddle mode than when experiencing dynamic flow. However, low concentrations of certain stabilizers (e.g., hydroxypyridine, including adventitious oxygen from air, etc.) or additional metal precursors such as molybdate (Mo04−2) can be used to compensate for or actually reverse such effects by exhibiting a greater inhibitory effects on small isolated features relative to larger features. This effect may be particularly obvious when using a static “puddle” plating mode (e.g., small to no fluid motion relative to the surface of the substrate). The ability to adjust the individual processing chemistries to a specific substrate pattern is thus an advantage.

Therefore, it may be desirable to vary the metal ion concentration, stabilizer concentration, and other electroless plating components based on the surface properties of the substrate and/or during different phases of the process to compensate for the deposition rate variation on the small isolated features and the larger features. For example, it may be advantageous to use an electroless plating chemistry that does not contain a stabilizer during the first initiation phases of the electroless deposition process to assure that the electroless deposition process initiates at the same time on all features and then change the composition of the electroless plating solution by adding a solution that contains a stabilizer to compensate for the deposition rate difference on the small isolated features and large features.

Recirculation Hardware

In one embodiment, the processing step 106B is performed by forming an electroless plating solution using the process(es) described in conjunction with step 106A, described above, and then delivered to the surface of the substrate 510. The flow of the electroless plating solution is continued until the electroless plating solution covers the substrate 510, flows over the edge of the substrate 510, and then fills a collection tank system 549. The collection tank system 549 generally contains a vessel (not shown) and a recirculation pump (not shown) that are adapted to recirculate the collected electroless plating solution collected in the collection tank system 549. After a desirable amount of the electroless plating solution is retained in the collection tank system 549 the isolation valve 471 is closed and the recirculation pump is used to cause a continuous flow of the collected fluid to the substrate 510 surface. The recirculation pump causes the collected fluid to flow through the insulated line 558, through the in-line heater 480 and out the nozzle 523 where it is dispensed on the substrate 510 and then recollected in the vessel contained in the collection tank system 549 so that it can be recirculated again by the recirculation pump. The flow rate of the collected electroless plating solution may range of about 100 ml/min to about 1000 mL/min.

Chamber Face-up Hardware

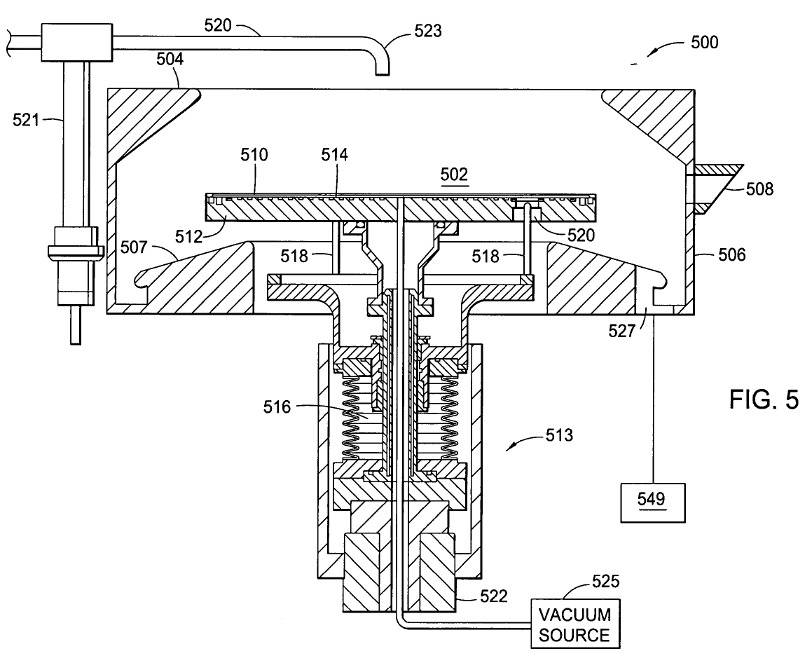

FIG. 5 shows a schematic cross-sectional view of one embodiment of a processing cell 500 useful for the deposition of an electroless layer as described herein. The processing cell 500 includes a processing compartment 502 comprising a top 504, sidewalls 506, and a bottom 507. A substrate support 512 is disposed in a generally central location in the processing cell 500. The substrate support 512 includes a substrate receiving surface 514 to receive the substrate 510 in a “face-up” position. In one aspect, having the substrate 510 disposed on the substrate support 512 in a “face-up” position reduces the possibility of bubbles in a fluid when applied to the substrate 510 from affecting the processing of the substrate 510. For example, bubbles may be created in the fluid in-situ, created in the fluid handling equipment, or may be created by transferring of a wet substrate. If the substrate was disposed in a “face-down position” during processing, bubbles in the fluid would be trapped against the surface of the substrate as a result of the buoyancy of the bubbles. Having the substrate in a “face-up” position reduces bubbles in the fluid from being situated against the surface of the substrate since the buoyant forces causes the bubbles to rise up in the fluid. Having the substrate in a face-up position also lessens the complexity of the substrate transfer mechanisms, improves the ability to clean the substrate during processing, and allows the substrate to be transferred in a wet state to minimize contamination and/or oxidation of the substrate.

The substrate support 512 may comprise a ceramic material (such as alumina Al₂O₃ or silicon carbide (SiC)), TEFLON™ coated metal (such as aluminum or stainless steal), a polymer material, or other suitable materials. TEFLON™ as used herein is a generic name for fluorinated polymers such as Tefzel (ETFE), Halar (ECTFE), PFA, PTFE, FEP, PVDF, etc. Preferably, the substrate support 512 comprises alumina. The substrate support 512 may further comprise embedded heated elements, especially for a substrate support comprising a ceramic material or a polymer material.

The processing cell 500 further includes a slot 508 or opening formed through a wall thereof to provide access for a robot (not shown) to deliver and retrieve the substrate 510 to and from the processing cell 500. Alternatively, the substrate support 512 may raise the substrate 510 through the top 504 of the processing compartment to provide access to and from the processing cell 500.

A lift assembly 516 may be disposed below the substrate support 512 and coupled to lift pins 518 to raise and lower lift pins 518 through apertures 520 in the substrate support 512. The lift pins 518 raise and lower the substrate 510 to and from the substrate receiving surface 514 of the substrate support 512.

A motor 522 may be coupled to the substrate support 512 to rotate the substrate support 512 to spin the substrate 510. In one embodiment, the lift pins 518 may be disposed in a lower position below the substrate support 512 to allow the substrate support 512 to rotate independently of the lift pins 518. In another embodiment, the lift pins 518 may rotate with the substrate support 512.

The substrate support 512 may be heated to heat the substrate 510 to a desired temperature. The substrate receiving surface 514 of the substrate support 512 may be sized to substantially receive the backside of the substrate 510 to provide uniform heating of the substrate 510. Uniform heating of a substrate is an important factor in order to produce consistent processing of substrates, especially for deposition processes having deposition rates that are a function of temperature. In one embodiment, it may be desirable to deliver the fluid processing solution(s), described above, at a temperature lower than the temperature of the substrate support (e.g., the electroless processing temperature) to reduce the chance of particle formation in the fluid processing solution prior to being dispensed on the substrate surface.

A fluid input, such as a nozzle 523, may be disposed in the processing cell 500 to sequentially deliver the buffered cleaning solution and a series of electroless plating solutions, and deionized water, to the surface of the substrate 510. The nozzle 523 may be disposed over the center of the substrate 510 to deliver a fluid to the center of the substrate 510 or may be disposed in any position. The nozzle 523 may be disposed on a dispense arm 528 positioned over the top 504 or through the sidewall 506 of the processing compartment 502. The dispense arm 528 may be moveable about a rotatable support member 521 which is adapted to pivot and swivel the dispense arm 528 and the nozzle 523 to and from the center of the substrate 510. Additionally or alternatively, a nozzle (not shown) may be disposed on the top 504 or sidewalls 506 of the processing cell 500 and adapted to spray a fluid in any desired pattern on the substrate 510.

The processing cell 500 further includes a drain 527 in order to collect and expel fluids used in the processing cell 500. The bottom 507 of the processing compartment 502 may comprise a sloped surface to aid the flow of fluids used in the processing cell 500 towards an annular channel in communication with the drain 527 and to protect the substrate support assembly 513 from contact with fluids.

A more detailed description of face-up processing cell may be found in the commonly assigned U.S. patent application Ser. No. 10/059,572, entitled “Electroless Deposition Apparatus” by Stevens et al., filed Jan. 28, 2002, which is incorporated by reference herein in its entirety to the extent not inconsistent with the claimed aspects and description herein.

Chamber Face-down Hardware

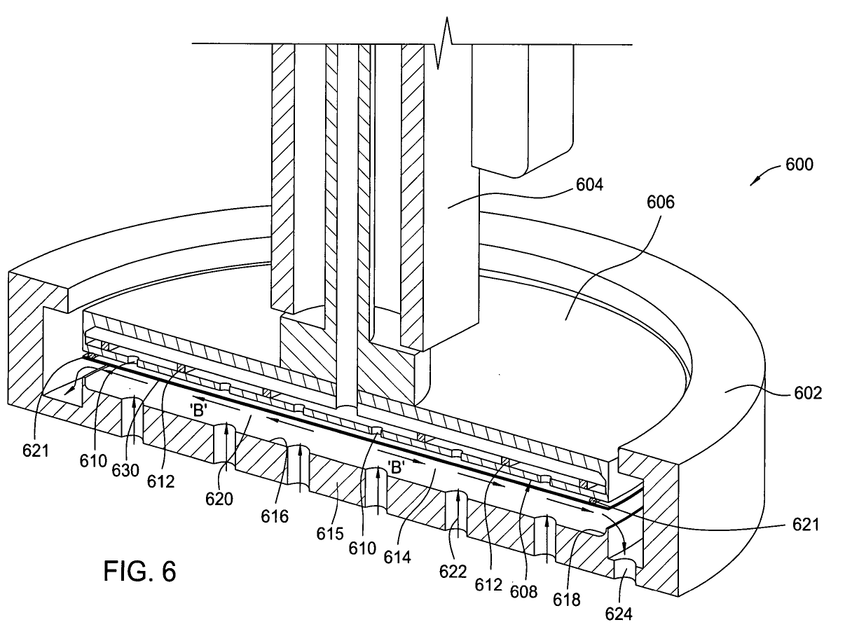

As illustrated in FIG. 6, the fluid processing cell 600 may be a face-down type fluid processing cell including a head assembly 604 configured to support a substrate 630 oriented such that the production surface (e.g., conductive surface 6A) is face down and to move the substrate downwards into a processing fluid provided in a cell body 602. The head assembly 604 generally includes a substrate support member 606 that is configured to rotate, horizontally or pivotally actuate, and vertically actuate as well as being sized to be received within the opening of cell body 602. The substrate support member 606 includes a substantially planar lower surface 608 that has a plurality of vacuum apertures 610 formed therein. The lower surface may be coated or manufactured from a material that is nonreactive with fluid processing solutions, such as ceramics or plastics. The vacuum apertures 610 are selectively in fluid communication with a vacuum source (not shown) such that the vacuum apertures 610 may be used to vacuum chuck a substrate 614 to the lower surface 608. An annular seal 621, such as an o-ring type seal, for example, near the perimeter of the substrate support surface 608 is configured to engage the backside of the substrate 614 to create a vacuum tight seal between the lower surface 608 and the substrate 614 while also preventing fluids from contacting the backside of the substrate. The interior of the substrate support member 606 may include a heater assembly 612, which may comprise a plurality of concentrically positioned heating bands. The heating bands may include resistive heaters, fluid passages configured to have a heated fluid flowed therethrough, or another method of heating a substrate support member for a semiconductor processing method. The plurality of heating bands may be individually controlled, if desired, to more accurately control the substrate temperature during processing. More particularly, individual control over the heating bands allows for precise control over the deposition temperature, which is critical to electroless plating processes. The substrate support member 606 may further include an actuator or vibration device (not shown) configured to impart megasonic or other vibrational energy to substrate 614 during processing.

The cell body 602 may be manufactured from various substances known to be nonreactive with fluid processing (electroless or ECP) solutions, such as plastics, polymers, and ceramics, for example. A bottom central portion of the cell body 602 includes a fluid processing basin 615. The basin 615 generally includes a substantially planar basin surface 616 having an annular fluid weir 618 circumscribing the basin surface 616. The fluid weir 618 generally has a height of between about 2 mm and about 20 mm, and is generally configured to maintain a processing fluid in a puddle-type configuration on the basin surface 616 in a processing region 620. The basin surface 616 also includes a plurality of fluid apertures 622 formed therein. The fluid apertures 622 are generally in fluid communication with a plurality of processing fluid sources, such as rinsing solution sources, activation solution sources, cleaning solution sources, electroless plating solution sources, and other fluid sources that may be used in an electroless deposition process. As such, apertures 622 may be used to supply processing fluids to the processing region 620. The processing fluid will generally flow upward through the apertures 622, and then outward through the processing region 620 toward weir 618, as indicated by arrows “B”. A fluid drain 624 is generally positioned in an outer lower portion of the cell body 602, generally outward of the fluid weir 618. As such, the fluid drain 624 is configured to collect fluid that overflows weir 618. The face down-type electroless plating cells, and processing platforms, described herein are more fully described in the commonly assigned provisional U.S. patent application Ser. No. 60/511,236, entitled, “Apparatus for Electroless Deposition”, filed on Oct. 15, 2003, and commonly assigned U.S. patent application Ser. No. 10/036,321, U.S. Publication No. 2003/0118732 entitled “Electroless Plating System”, filed on Dec. 26, 2001, both of which are incorporated by reference herein in their entireties to the extent not inconsistent with the claimed aspects and description herein.

Fluid Deliverv Process

In one aspect of the process 100, the various fluid processing solutions are delivered to the surface of a substrate using a continuous flow of fluid. The term fluid processing solutions is generally meant to describe various processing fluids (i.e., described in step 104), electroless plating solutions (i.e., described in step 106A, 106B and 108) and/or rinse solutions (i.e., described in step 110). In this configuration the total flow of the fluid processing solutions used to perform the various processing steps (i.e., steps 104-110) may be varied as desired to meet the processing needs, but the a flow of the fluid processing solutions onto the substrate surface is usually greater than zero. The use of an uninterrupted flow may be advantageous to assure that a fresh concentration of solution is continually delivered to the substrate surface to minimize process variations caused by changing chemical concentrations during processing and reduce the chance of surface oxidation. Also, the use of an uninterrupted flow will minimize the total chamber processing time, since time is not wasted completing non-value added steps, such as, adding and removing the chemical from the surface of the substrate.

In another aspect, the flow of the fluid processing solutions are paused for a user defined period of time once the delivered fluid processing solution covers the substrate surface. The flow is then reinitiated after the user defined time has expired so that the next fluid processing solution can be delivered to the substrate surface. This configuration thus allows the fluid processing solution retained on the surface of the substrate, time to complete the desired process, while reducing the process chamber waste. This configuration may also prevents or minimizes the exposure of the surface of the substrate to possible sources of oxygen or other contaminants, by assuring that the substrate surface is covered with a fluid processing solution.

In another aspect, a flow of a first fluid processing solution is dispensed and retained on the surface of a substrate for a period of time and then a second fluid processing solution is added to the volume of the first fluid processing solution and retained on the surface of the substrate for a second user defined period of time. In one aspect it may be advantageous to use a first fluid processing solution and a second fluid processing solution that have a different composition so that two layers having a different composition can be deposited in one continuous process. In one aspect, it may also be advantageous to dispense a first volume of the first processing fluid that has a smaller volume than the volume of the second fluid so that the first processing solution doesn't significantly dilute the solution formed when the second solution is added to the first solution. In one aspect, it may also be advantageous to dispense the first processing solution, and other processing fluids, using a spray or mist dispense process to get fast and uniform coverage of the surface substrate surface. This configuration thus allows the thin layer of fluid retained on the surface of the substrate, time to complete their respective processes, while reducing the process chamber waste. This configuration may also prevents or minimizes the exposure of the surface of the substrate to possible sources of oxygen or other contaminants, by assuring that the substrate surface is covered with a fluid processing solution.

In yet another aspect, it may be advantageous to remove the fluid processing solution covering the substrate surface by, for example, rotating the substrate, after one step is completed but before the flow of the next fluid processing solution is reinitiated to reduce the dilution effect caused by mixing the two fluid processing solutions. In this case the exposure of the substrate surface to the atmosphere may be minimized to reduce the chance of oxidation or contamination by assuring the fluid processing solution removal process leaves the substrate surface “wet” with the original fluid processing solution. This step may be completed by reinitiating the flow of the next fluid processing solution before the substrate surface is completely removed. In one aspect, the use of fluid processing solutions that contain DEA, TEA, surfactants and/or other wetting agents can reduce the likelihood of exposure of the conductive surfaces since the use of this component will reduce the likelihood of evaporation and/or drying of the surfaces exposed to the fluid processing solution. In one aspect, the flow of the next fluid processing solution is initiated at the same time the process of removing the prior fluid processing solution begins to minimize the exposure of the substrate surface to oxygen or other contaminants.

Preclean Process

In one embodiment of process 100, a preclean step is added prior to the step 102, so that any surface oxidation can be removed from the conductive surfaces 6A prior to transferring the substrate to the electroless processing chamber. This configuration may be useful in allowing the use of more cost effective cleaning agents that are incompatible with the electroless process chemicals. The preclean process generally requires the steps of exposing the surface of the substrate to a preclean solution for a period of time long enough to assure that the oxide layer is removed, but not long enough to remove an appreciable amount of the conductive surface layer 6A. In one aspect, to prevent re-oxidation of the conductive surface after the preclean process has been performed and before the next process 100 step (e.g., process steps 104, 106A and/or 106B) has started, the substrate is transferred in an environment that contains a low concentration of oxygen. An exemplary system, apparatus and process of processing substrates in an environment that contains a low concentration of oxygen is further described in the U.S. patent application Ser. No. 10/996,342 entitled “Apparatus For Electroless Deposition Of Metals On Semiconductor Wafers” and filed on Nov. 22, 2004, which is incorporated by reference herein in their entireties to the extent not inconsistent with the claimed aspects and description herein.

The preclean solution is generally an aqueous solution containing an acid that is delivered to the substrate surface at a temperature between about 30° C. and about 85° C. The acid is used to dissolve the metal oxides on the conductive surfaces 6A. Preferable acids include sulfuric acid (H₂SO₄), acetic acid (C₂H₄O₂), citric acid (C₆H₈O₇), methanesulfonic acid (CH₃SO₃H), and/or combinations and derivatives thereof. The acid may have a concentration sufficient to produce a solution having a pH within a range from about 0.5 Molar (M) to about 3.5 M.

Process Example #1

In one embodiment, a capping layer is formed on a copper feature by a process that first cleans the surface of the exposed copper features by use of a buffered cleaning solution, then depositing a cobalt alloy that contains some amount tungsten, then depositing a tungsten free cobalt containing layer, and then rinsing the substrate. An example of an exemplary process is described below.

In this process the first processing solution is delivered to the surface of the substrate to remove the oxides from the surface of the substrate. The first processing solution is formed in the insulated line 419 by mixing DI water 414 with one part of a buffered cleaning solution concentrate 440. The buffered cleaning solution concentrate 440 contains 121 g/L DEA, 22.4 g/L glycine, 72 g/L citric acid, 6.2 g/L boric acid, DI water, and an amount of TMAH (25%) sufficient to adjust the pH to about 9.45. The mixture of the buffered cleaning solution concentrate 440 is combined with a flow of heated DI water in a ratio of about 9:1 (i.e., DI water:buffered cleaning solution concentrate 440a) to form a solution containing: 0.115 M DEA, 0.030 M glycine, 0.0375 M citric acid, and 0.010 M boric acid. The temperature of the final solution was between about 55° C. to about 60° C. A flow rate of the first processing solution delivered to the surface of the substrate is about 400 mL/min for a period of time of about 15 seconds.

After removing the oxides by use of the buffered cleaning solution a metal layer containing CoWPB is electrolessly deposited on the conductive surface 6A, by forming a first electroless plating solution by injecting a flow of a buffered reducing agent 460a and a first metal solution 450a into the flow of the first processing solution. The buffered reducing agent 460a contains about 12 g/L DMAB, 33 g/L of H₃PO₂, 72 g/L of citric acid, 0.1 g/L of hydroxypyridine, and enough TMAH to achieve a pH from about 9.25. The first metal solution 450a contains 23.8 g/L of CoCl₂.6H₂O, 74.4 g/L of citric acid, 5.0 g/L of tungstic acid, 0.2 g/L of SDS and enough TMAH to achieve a pH of about 9.25. Therefore, to keep the flow constant, the dilution of the various components are maintained at a ratio of about 7:1:1:1 (i.e., DI water:buffered cleaning solution concentrate 440:first metal solution 450a: buffered reducing agent 460a) to form a solution containing: 0.115 M of DEA, 0.030 M of glycine, 0.112 M of citrate, 0.010 M of boric acid, 0.10 M of CoCl₂.6H₂O, 0.002 M of tungstic acid, 20 ppm of SDS, 0.02 M of DMAB, 0.025 M of H₃PO₂, and 10 ppm of hydroxypyridine. The temperature of the final solution was about 55° C. to about 60° C. A flow rate of about 400 mL/min is delivered to the surface of the substrate for a period of about 60 seconds.

After electrolessly depositing a metal layer containing CoWPB, a metal layer containing CoB is electrolessly deposited on the CoWB layer, by halting the flow of the first metal solution 450a and the buffered reducing agent 460a, and initiating the flow of the second metal solution 450b and a second buffered reducing agent 460b. The second metal solution 450b contains 23.8 g/L of CoCl₂.6H₂O, 74.4 g/L of citric acid, 0.2 g/L of SDS and enough TMAH to achieve a pH of about 9.25. The second buffered reducing agent 460b solution contains 12 g/L DMAB, 72 g/L of citric acid, 0.1 g/L of hydroxypyridine, DI water and enough TMAH to achieve a pH of about 9.25. Therefore, to keep the flow constant, the dilution of the various components are maintained at a ratio of about 7:1:1:1 (i.e., DI water:buffered cleaning solution concentrate 440:second metal solution 450b: buffered reducing agent 460b) to form a solution containing: 0.115 M of DEA, 0.030 M of glycine, 0.112 M of citric acid, 0.010 M of boric acid, 0.10 M of CoCl₂.6H₂O, 20 ppm of SDS, 0.02 M of DMAB, and 10 ppm of hydroxypyridine. The temperature of the final solution was about 55° C. to about 60° C. A flow rate of about 400 mL/min is delivered to the surface of the substrate for a period of about 15 seconds.

After electrolessly depositing a metal layer containing CoB the substrate is rinsed by halting the flow of buffered cleaning solution concentrate 440, the second metal solution 450b, and the flow of the second buffered reducing agent 460b. The flow rate of the DI water is about 400 mL/min is delivered to the surface of the substrate for a period of about 30 seconds, after which the substrate is rinsed with cold DI water for and additional 60 seconds.

Process Example #2

In one embodiment, a capping layer is formed on conductive surfaces on a substrate using a process where the substrate is pre-cleaned in a first processing chamber and then delivered to a second processing chamber so that an electroless process can be performed on the substrate surface. The electroless process may comprise the steps of first depositing a cobalt alloy that contains some amount tungsten, then depositing a cobalt containing material, and then rinsing the substrate. An example of an exemplary process is described below.

First, the substrate surface was cleaned using a preclean process. The preclean process comprises rinsing the substrate surface with an aqueous preclean solution that contains: 0.01 M of citric acid and 0.025 M methanesulfonic acid to achieve a pH of about 1.8. The preclean solution is delivered to the substrate surface at a temperature between about 20° C. and 25° C. A flow rate of the preclean solution delivered to the surface of the substrate is about 400 mL/min for a period of time of about 15 seconds.

After completing the preclean process in the first processing chamber the substrate is then delivered to the second processing chamber in an environment containing less than 100 ppm of oxygen. After removing the oxides by use of the preclean process a metal layer containing CoWPB is electrolessly deposited on the conductive surface 6A, by forming a first electroless plating solution by injecting a flow of a buffered cleaning solution concentrate 440, a buffered reducing agent 460a and a first metal solution 450a into the flow of heated DI water. The buffered reducing agent 460a contains about 12 g/L DMAB, 33 g/L of H₃PO₂, 72 g/L of citric acid, 0.1 g/L of hydroxypyridine, and enough TMAH to achieve a pH of about 9.45. The first metal solution 450a contains 23.8 g/L of CoCl₂.6H₂O, 74.4 g/L of citric acid, 5.0 g/L of tungstic acid, 0.2 g/L of SDS and enough TMAH to have a pH from about 9.25. The various components are maintained at a ratio of about 7:1:1:1 (i.e., DI water:buffered cleaning solution concentrate 440:first metal solution 450a:buffered reducing agent 460a) to form a solution containing: 0.115 M of DEA, 0.030 M of glycine, 0.112 M of citric acid, 0.010 M of boric acid, 0.10 M of CoCl₂.6H₂O, 0.002 M of tungstic acid, 20 ppm of SDS, 0.02 M of DMAB, 0.025 M of H₃PO₂, and 10 ppm of hydroxypyridine. The temperature of the final solution was about 55° C. to about 60° C. A flow rate of about 400 mL/min is delivered to the surface of the substrate to form a puddle, which is retained on the substrate surface for a period of about 60 seconds.

After electrolessly depositing a metal layer containing CoWPB, a metal layer containing CoB is electrolessly deposited on the CoWB layer, by halting the flow of the first metal solution 450a and the buffered reducing agent 460a, and initiating the flow of the second metal solution 450b and a second buffered reducing agent 460b. The second metal solution 450b contains 23.8 g/L of CoCl₂.6H₂O, 74.4 g/L of citric acid, 0.2 g/L of SDS and enough TMAH to have a pH from about 9.25. The second buffered reducing agent 460b solution contains 12 g/L DMAB, 72 g/L of citric acid, 0.1 g/L of hydroxypyridine, DI water and enough TMAH to have a pH from about 9.25. Therefore, to keep the flow constant, the dilution of the various components are maintained at a ratio of about 7:1:1:1 (i.e., DI water:buffered cleaning solution concentrate 440:second metal solution 450b:buffered reducing agent 460b) to form a solution containing: 0.115 M of DEA, 0.030 M of glycine, 0.112 M of citric acid, 0.010 M of boric acid, 0.10 M of CoCl₂.6H₂O, 20 ppm of SDS, 0.02 M of DMAB, and 10 ppm of hydroxypyridine. The temperature of the final solution was about 55° C. to about 60° C. A flow rate of about 400 mL/min is delivered to the surface of the substrate just as the first processing solution is being removed by rotation of the substrate. After most of the first processing solution (e.g., CoWPB deposition solution) is removed the flow of the second processing solution (e.g., CoB deposition solution) is continued until a puddle is formed on the surface of the substrate. The puddle of the second processing solution is then retained on the surface of the substrate for a period of about 15 seconds.

After electrolessly depositing a metal layer containing CoB the substrate is rinsed by halting the flow of buffered cleaning solution concentrate 440, the second metal solution 450b, and the flow of the second buffered reducing agent 460b. The flow rate of the DI water is about 400 mL/min is delivered to the surface of the substrate for a period of about 30 seconds, after which the substrate is rinsed with cold DI water for and additional 60 seconds.

While the foregoing is directed to embodiments of the invention, other and further embodiments of the invention may be devised without departing from the basic scope thereof, and the scope thereof is determined by the claims that follow.

1. A method of forming two or more metal layers on an exposed conductive surface on a substrate using a continuous electroless deposition process comprising:
forming a first electroless deposited layer using a first processing solution that contains a concentration of a first chemical component that will remove or reduce metal oxides formed on a conductive surface on a substrate; and
forming a second electroless deposited layer on the first electrolessly deposited layer using a second processing solution that contains a concentration of the first chemical component, wherein the first component contained in the first processing solution and the second processing solution is in uninterrupted contact with the conductive surface once the process of forming the first electroless deposited layer has begun until the process of forming the second electroless deposited layer has finished.

2. The continuous electroless deposition process of claim 1, further comprising:
cleaning the substrate surface using a buffered cleaning solution that contains a concentration of the first chemical component prior to forming the first electroless deposited layer.

3. The continuous electroless deposition process of claim 1, wherein the first component selected from the group of: glycine (C₂H₅NO₂), diethanolamine ((HOCH₂CH₂)₂NH), triethanolamine ((HOCH₂CH₂)₃N), ethanolamine ((HOCH₂CH₂)NH₂), ethylenediaminetetraacetic acid (C₁₀H₁₆N₂O₈), acetic acid (C₂H₄₂), lactic acid (C₃H₆O₃), citric acid (C₆H₈O₇) and combinations and deriva thereof.

4. The continuous electroless deposition process of claim 2, wherein the buffered cleaning solution is an aqueous solution that comprises an acid, a complexing agent, a buffer and/or a pH adjuster.

5. The continuous electroless deposition process of claim 1, wherein the first processing solution comprises a cobalt containing component and a tungsten containing component, and the second processing solution comprises a cobalt containing component.

6. The continuous electroless deposition process of claim 1, wherein the composition of the first processing solution or the second processing solution comprises an oxidation-resistant metal selected from a group consisting of gold, silver, platinum, palladium, rhodium, ruthenium, iridium, ruthenium, and combinations thereof.

7. The continuous electroless deposition process of claim 1, wherein the conductive surface comprises at least one element selected from a group consisting of copper (Cu), palladium (Pd), silver (Ag), aluminum (Al), cobalt (Co), gold (Au), nickel (Ni), zinc (Zn), platinum (Pt), and tin (Sn).

8. The continuous electroless deposition process of claim 1, wherein the first layer comprises at least one element selected from a group consisting of cobalt (Co), nickel (Ni), molybdenum (Mo), tungsten (W), ruthenium (Ru), palladium,(Pd) rhodium (Rh), iridium (Ir), and platinum (Pt).

9. A continuous electroless deposition process for fabricating a multilayered film on a conductive surface on a substrate, comprising the following steps:
electrolessly depositing a first layer on a conductive surface on a substrate by completing at least one of the following steps:
delivering a first processing solution to the surface of the substrate, wherein the first processing solution comprises a first metal solution and a first buffered reducing agent solution; and
delivering a second processing solution to the surface of the substrate, wherein the second processing solution comprises a second metal solution, a buffered cleaning solution and a second buffered reducing agent solution; and
electrolessly depositing a second layer on the first layer by completing at least one of the following steps:
delivering a third processing solution to the surface of the substrate, wherein the third processing solution comprises a third metal solution and a third buffered reducing agent solution; and
delivering a fourth processing solution to the surface of the substrate, wherein the fourth processing solution comprises a fourth metal solution, a buffered cleaning solution and a fourth buffered reducing agent solution.

10. The continuous electroless deposition process of claim 9, further comprising:
flowing a first processing solution onto a surface of a substrate prior to electrolessly depositing the first layer, wherein the first processing solution contains a buffered cleaning solution.

11. The continuous electroless deposition process of claim 9, wherein the buffered cleaning solution of the first processing solution removes oxides from the conductive surface.

12. The continuous electroless deposition process of claim 9, wherein the buffered cleaning solution comprises an acid, a complexing agent, a buffering agent and/or a pH adjuster, and water.

13. The continuous electroless deposition process of claim 9, wherein the first, second, third and fourth buffered reducing agent solution comprises a phosphorus containing solution, a boron containing solution, or a combination thereof.

14. The continuous electroless deposition process of claim 9, wherein the first metal solution or the second metal solution comprises a cobalt containing component and a tungsten containing component.

15. The continuous electroless deposition process of claim 9, wherein the composition of the first metal solution or the second metal solution comprises an oxidation-resistant metal selected from a group consisting of gold, silver, platinum, palladium, rhodium, ruthenium, osmium, iridium, ruthenium, and combinations thereof.

16. The continuous electroless deposition process of claim 9, wherein the conductive surface comprises at least one element selected from a group consisting of copper (Cu), palladium (Pd), silver (Ag), cobalt (Co), gold (Au), nickel (Ni), zinc (Zn), platinum (Pt), and tin (Sn).

17. The continuous electroless deposition process of claim 9, wherein the first layer and second layer comprises at least one element selected from a group consisting of cobalt (Co), nickel (Ni), molybdenum (Mo), tungsten (W), ruthenium (Ru), palladium,(Pd) rhodium (Rh), iridium (Ir), and platinum (Pt).

18. The continuous electroless deposition process of claim 9, wherein the first layer comprises a thickness between about 1 Å and about 500 Å.

19. The continuous electroless deposition process of claim 9, wherein the second layer comprises a thickness between about 1 Å and about 500 Å.

20. The continuous electroless deposition process of claim 9, further comprising:
characterizing the density and/or surface area of the conductive surfaces found on a surface of a substrate;
adjusting the flow of the buffered cleaning solution, the first metal solution, the first buffered reducing agent solution, the second metal solution, the second buffered reducing agent solution, third metal solution, the third buffered reducing agent solution, fourth metal solution, and/or the fourth buffered reducing agent solution based on the characterized conductive surface data.

21. A continuous electroless deposition process for fabricating a multilayered film on a conductive surface on a substrate, comprising the sequential steps of:
flowing a first solution containing a buffered cleaning solution over a conductive surface on a substrate;
electrolessly depositing a first layer having a first composition on the conductive surface by:
adding a flow of a first metal solution to the flow of the first solution; and
adding a flow of a first buffered reducing agent solution to the flow of the first solution; and
electrolessly depositing a second layer having a second composition on the conductive surface by:
adding a flow of a second metal solution to the flow of the first solution; and
adding a flow of a second buffered reducing agent solution to the flow of the first solution.

22. The continuous electroless deposition process of claim 21, wherein the first metal solution and the second metal solution are the same solution.

23. The continuous electroless deposition process of claim 21, wherein the first solution contains DI water that has been degassed and heated to a temperature between about 50° C. and about 95° C.

24. The continuous electroless deposition process of claim 21, wherein the process of electrolessly depositing a first layer and/or electrolessly depositing a second layer is completed by halting the flow of the first metal solution, the first buffered reducing agent solution and the flow of the first solution and/or the flow of the second metal solution, the second buffered reducing agent solution and the flow of the first solution for a period of time.

25. The continuous electroless deposition process of claim 22, wherein adding a flow of a second buffered reducing solution comprises decreasing a first flow rate of the first buffered reducing solution and increasing a second flow rate of the second buffered reducing solution.

26. The continuous electroless deposition process of claim 25, wherein a combination of the first flow rate of the first buffered reducing solution and the second flow rate of the second buffered reducing solution is maintained at a constant value.

27. The continuous electroless deposition process of claim 21, wherein the first metal solution comprises a cobalt containing solution and a tungsten containing solution.

28. The continuous electroless deposition process of claim 21, wherein the first buffered reducing agent solution or the second buffered reducing agent solution comprises phosphorus, boron, or a combination thereof.

29. The continuous electroless deposition process of claim 21, further comprising adding a flow of a second metal solution to the flow of the first buffered reducing agent solution or the second buffered reducing agent solution to form an electroless plating solution.

30. The continuous electroless deposition process of claim 29, wherein adding the flow of a second metal solution comprises decreasing a first flow rate of the first metal solution and increasing a second flow rate of the second metal solution.

31. The continuous electroless deposition process of claim 21, wherein the composition of the second metal solution comprises an oxidation-resistant metal selected from a group consisting of gold, silver, platinum, palladium, rhodium, ruthenium, osmium, iridium, and combinations thereof.

32. A continuous self-limiting electroless deposition process for fabricating a multilayered film on a conductive surface of a substrate disposed in a processing cell, comprising the sequential steps of:
flowing a buffered cleaning solution over the conductive surface;
adding a metal solution to the flowing buffered cleaning solution;
adding a buffered reducing agent solution to the flowing buffered cleaning solution to form a first electroless plating solution and electrolessly depositing a first layer having a first composition on the conductive surface; and
recirculating the buffered cleaning solution, the metal solution and the buffered reducing agent solution to autocatalytically deposit a second layer over the first layer.

33. An apparatus for forming a multilayered film on a conductive surface of a substrate comprising:
a substrate support mounted in an electroless plating cell having a substrate receiving surface;
a fluid delivery line that is in communication with a substrate positioned on the substrate receiving surface;
a first fluid metering device that is in communication with a first fluid source and the fluid delivery line;
a second fluid-metering device that is in communication with a second fluid source and the fluid delivery line; and
a controller adapted to control the concentration and flow rate of a fluid contained in the fluid delivery line by controlling the flow delivered by the first and second fluid metering devices.

34. The apparatus of claim 33, further comprising:
a third fluid metering device that is in communication with a third fluid source and the fluid delivery line; and
a controller adapted to control the concentration and flow rate of a fluid contained in the fluid delivery line by controlling the flow delivered by the first, second and third fluid metering devices.

35. The apparatus of claim 33, wherein the first fluid source contains a DI water source and the second fluid source contains a buffered cleaning solution source.

36. The apparatus of claim 33, wherein the first fluid source further comprises:
a fluid degassing device adapted to remove trapped gasses contained in a fluid delivered from a fluid source; and
a heater adapted to heat the fluid delivered from the first fluid source.

37. The apparatus of claim 36, wherein the fluid source is a DI water source.

38. A multilayer structure formed on the surface of a copper interconnect comprising:
a first layer that contains at least two of the following elements cobalt (Co), tungsten (W), molybdenum (Mo), phosphorus (P) or boron (B); and
a second layer that contains at least two of the following elements cobalt (Co), boron (B) or phosphorus (P).

39. The multilayer structure of claim 38, wherein the first layer is formed using either an electroless self-initiating process or by activating the substrate by displacement plating with a catalytic metal such as palladium Pd, ruthenium Ru, rhodium (Rh) iridium (Ir) or platinum (Pt).

40. A continuous electroless deposition process for fabricating a multilayered film on a conductive surface on a substrate, comprising the sequential steps of:
flowing a preclean solution containing an acid over a conductive surface on a substrate retained in a first processing chamber;
transferring the substrate from a first processing chamber to a second processing chamber;
electrolessly depositing a first layer having a first composition on the conductive surface by delivering a first electroless plating solution that contains at least a first metal solution and a first buffered reducing agent solution to the conductive surface;
electrolessly depositing a second layer having a second composition on the conductive surface by delivering a second electroless plating solution that contains at least a second metal solution and a second buffered reducing agent solution to the conductive surface, wherein the composition of the first layer and the second layer are different.

41. A method of forming two or more metal layers on an exposed conductive surface on a substrate using a continuous electroless deposition process comprising:
characterizing the density and/or surface area of the conductive surfaces found on a surface of a substrate;
adjusting the metal ion concentration in a first electroless processing solution based on the characterized conductive surface data;
forming a first layer on the conductive surfaces on the substrate using the first electroless processing solution;
forming a second electroless processing solution that contains a stabilizer; and
forming a second layer on the first layer using the second electroless processing solution.

42. A continuous electroless deposition process for fabricating a multilayered film on a conductive surface on a substrate, comprising the sequential steps of:
flowing a first solution containing a buffered cleaning solution over a conductive surface on a substrate;
flowing a second solution containing a buffered cleaning solution, a first metal solution, and a first buffered reducing agent solution over a conductive surface on a substrate;
halting the flow of the second solution after a puddle of the second solution is formed over the conductive surfaces on the substrate;
pausing for a first user defined time; flowing a third solution containing a buffered cleaning solution, a second metal solution, and a second buffered reducing agent solution over a conductive surface on a substrate; and
halting the flow of the third solution after a puddle of the third solution is formed over the conductive surfaces on the substrate.

43. The continuous electroless deposition process of claim 42, wherein the first metal solution comprises a cobalt containing solution, a tungsten containing solution and/or a molybdenum containing solution.

44. The continuous electroless deposition process of claim 42, wherein the second metal solution comprises a solution containing cobalt, no tungsten and no molybdenum.

45. The continuous electroless deposition process of claim 42, wherein the first buffered reducing agent solution or the second buffered reducing agent solution comprises phosphorus, boron, or a combination thereof.

46. A method of forming two or more metal layers on an exposed conductive surface on a substrate using a continuous electroless deposition process comprising:
cleaning a surface of a substrate using a buffered cleaning solution;
forming a first electroless deposited layer comprising elements selected from the group of cobalt, molybdenum, tungsten, boron and phosphorus; and
forming a first electroless deposited layer consisting essentially of cobalt and phosphorus or cobalt and boron.
